(19) United States
(12) Patent Application Publication
(10) Pub. No.: US 2012/0072235 A1
(43) Pub. Date: Mar. 22, 2012

(54) System and Method for Personal Healthcare Analysis and Distributable Archive

(75) Inventors: Sridhar Varadarajan, Bangalore (IN); Sridhar Gangadharpalli, Bangalore (IN); Amit Thawani, Bangalore (IN)

(73) Assignee: SRM INSTITUTE OF SCIENCE AND TECHNOLOGY, West Mambalam (IN)

(21) Appl. No.: 12/977,224

(22) Filed: Dec. 23, 2010

(30) Foreign Application Priority Data
Sep. 16, 2010 (IN) 2710/CHE/2010

(51) Int. Cl. G06Q 50/00; G06Q 10/00

(52) U.S. Cl. 705/3

(57) ABSTRACT

An individual has a large number of health related transactions during their lifecycle right from birth. As technology is fast evolving and medical profession demanding accurate description of a situation for effective handling of the patients, it is very useful, and often a necessity, to keep a record of all of the health related transactions. A system and method for recording the large and growing number of health transactions in a structured manner, analyzing and relating of the same, and making them available to any agency is described. The structuring of the transactions is based on a set of dimensions and the analysis leads to the linking of the transactions across these dimensions and deriving of the meta-information for assisting the individual to be more health conscious.

### FIELD OF THE INVENTION

The present invention relates to the healthcare analysis in general, and more particularly, analysis of personal healthcare records of individuals. Still more particularly, the present invention relates to a system and method for the structuring and analysis of personal healthcare records for achieving distributable archiving and for increasing health consciousness.

### BACKGROUND OF THE INVENTION

Healthcare is an important aspect of a society and it is a mandate for the society to ensure that every person on this planet remains healthy. The whole gamut of hospitals, doctors, nurses, labs, technicians, pharmacists, health advisors, and insurance agencies collectively assure the well being of the society in general and the individuals in particular. While attending to an individual, a doctor would have several questions about the individual especially related to just past activities and illnesses. How accurately can such questions be answered? A good medication leading to a quicker recovery many a times depend on the accuracy of the above answers. How many individuals can answer such questions accurately? More importantly, is it possible for a layman to understand comprehensively the questions of medical professionals' let alone confidently answering them. In order to handle this situation, several technologies and open standards are being developed: technologies help achieve comprehensiveness and standards help in global adaptation. The Unified Medical Language System (http://umlsks.nlm.nih.gov) is an initiative of US National Library of Medicine. UMLS is a comprehensive repository of biomedical vocabularies. The UMLS provides 900,000 concepts in which over two million names are integrated. Further, these concepts are derived from sixty families of biomedical vocabularies and provide twelve million relations among these concepts. UMLS Metathesaurus includes Vocabularies derived from the NCBI taxonomy (National Center for Biotechnology Information), Gene Ontology, the Medical Subject Headings (MeSH), OMIM (Online Mendelian Inheritance in Man) and the Digital Anatomist Symbolic Knowledge Base. One of the interesting features of UMLS is that concepts are not only inter-related, but may also be linked to external resources such as GenBank. The UMLS knowledge sources are updated quarterly. Also, UMLS includes tools for customizing the Metathesaurus known as “MetamorphoSys”, and a tool for generating lexical variants of concept names called “Ivg”, and for extracting UMLS concepts from text called “MetaMap.” Similarly, SNOMED (Systematized Nomenclature of Medicine) represents a standardized clinical terminology which is the most comprehensive, multilingual healthcare terminology available (as on August 2010) (http://www.ihtsdo.org/snomed-ct/). SNOMED provides a comprehensive nomenclature of clinical medicine for facilitating accurate storing and retrieving healthcare records in human and veterinary medicine. In SNOMED, diseases and procedures are ordered hierarchically and are further referenced back to more elementary terms of medical terminology. SNOMED's reference ontology has a Multi-Axial Design, with 11 axes. SNOMED is designed for representing complex concepts defined in term of simpler ones. A disease for instance can be defined in terms of its abnormal anatomy, abnormal functions and morphology. This in some cases helps identify the relations between a disease to an infectious agent, or a chemical or pharmaceutical agent. From the standardization point of view, for instance, the efforts of openEHR (http://www.openehr.org/home.html) initiative provide an elaborate description of electronic health records (EHRs): it is about enabling technology to effectively support healthcare, medical research, and related areas and providing of semantically enabled health computing platform. Its objective is to support adaptable health computing systems and patient-centric electronic health records. While this addresses the bulk of the information to be cataloged, it is placed on record that multiple viewpoints need to be addressed with patient-centric being one of them and this leads to the notion of person-centric health records as an individual transitions from being healthy to a patient state and hence, it is equally important to catalog what happens when the individual is healthy. The present invention is related to the issue of collecting, organizing, and analyzing of the individual's heath related records: the system, Personal Healthcare Analysis and Distributable Archiving (pHANDA), effectively addresses this requirement.

### DESCRIPTION OF RELATED ART

U.S. Pat. No. 7,707,047 to Hasan; Malik M. (Las Vegas, Nev.), Peterson; John C. (Tucson, Ariz.), Wallen; J. Dominic (Tucson, Ariz.) for “Method and system for generating personal/individual health records” (issued on Apr. 27, 2010 and assigned to HealthTrio LLC (Centennial, Colo.)) a system and method for generating and/or updating a personal/individual health record, wherein inputs of data to the system may come from diverse sources including, but not limited to, patient questionnaires, insurance company claims data, hospitals, clinics and other institutional providers, and individual physicians and physicians' offices.

U.S. Pat. No. 7,647,320 to Mok; Megan Wai-Han (Pacifica, Calif.), Jopling; Arthur Douglas (San Rafael, Calif.), Holvey; R. David (Pacifica, Calif.), Mattox; Joel D. (Saratoga, Calif.) for “Patient directed system and method for managing medical information” (issued on Jan. 12, 2010 and assigned to Peoplechart Corporation (San Francisco, Calif.)) describes a system and method for the management of a patient's medical records by a central data repository under the direction of the patient and enabled by an entity managing records on behalf of the patient.

U.S. Pat. No. 7,621,445 to Esseiva; Effron F. D. (Bowen Island, Calif.), Kol; Tomer (Yoqneam Illit, Ill.), Stevens; Richard J. (Rochester, Minn.) for “Method and apparatus for access to health data with portable media” (issued on Nov. 24, 2009 and assigned to International Business Machines Corporation (Armonk, N.Y.)) describes a method and apparatus for managing electronic medical records that includes defining a tiered hierarchy of medical record storage categories.

U.S. Pat. No. 7,613,620 to Salwan; Angadbir Singh (Potomac, Md.) for “Physician to patient network system for real-time electronic communications and transfer of patient health information” (issued on Nov. 3, 2009) describes a physician to patient network system that is a private and secure infrastructure for independently practicing physicians and patients for real-time electronic communication and transfer of patient health information.

U.S. Pat. No. 7,487,102 to Castille; Debra (Harrisonville, Mo.) for “Process of interfacing a patient indirectly with their own electronic medical records” (issued on Feb. 3, 2009) describes a process of allowing a patient to have limited input access to their electronic medical record including providing the patient with a machine readable medical questionnaire concerning their history, environment, symptoms, and other pertinent information for answering by the patient and updating the patient's medical records.

U.S. Pat. No. 7,454,359 to Rosenfeld; Brian A. (Baltimore, Md.), Breslow; Michael (Lutherville, Md.) for “System and method for displaying a health status of hospitalized patients” (issued on Nov. 18, 2008 and assigned to VISICU, Inc. (Baltimore, Md.)) describes a system and method for displaying a health status of hospitalized patients wherein patient data associated with hospitalized patients is selected according to display rules.

U.S. Pat. No. 7,379,946 to Carus; Alwin B. (Waban, Mass.), Ogrinc; Harry J. (Westwood, Mass.) for “Categorization of information using natural language processing and predefined templates” (issued on May 27, 2008 and assigned to Dictaphone Corporation (Stratford, Conn.)) describes methods and systems for classifying and normalizing information using a combination of traditional data input methods, natural language processing, and predetermined templates.

U.S. Pat. No. 5,867,821 to Ballantyne; Douglas J. (Nepean, Calif.), Mulhall; Michael (Ottawa, Calif.) for “Method and apparatus for electronically accessing and distributing personal health care information and services in hospitals and homes” (issued on Feb. 2, 1999 and assigned to Paxton Developments Inc. (Ottawa, Calif.)) describes a system for the distribution and administration of medical services, entertainment services, electronic medical records, educational information, etc. to a patient's individual electronic patient care station (PCS) interconnected to a master library (ML) which stores data in digital compressed format, through a local medical information network.

“Management and maintenance policies for EHR interoperability resources” by Kalra; Dipak, Freriks; Gerard, Mennerat; François, Devlies; Jos, Tapuria; Archana, and Thienpont; Geert (a report, Q-REC Project, European Quality Labelling and Certification of Electronic Health Record Systems, 2008) describes the quality management and maintenance landscape for four kinds of resource that support the interoperability of electronic health records, namely, Clinical archetypes, Open source components and XML Schemas, Legislative and industry standards, and Coding schemes and terminology systems.

“Electronic Health Records Overview” by The MITRE Corporation (a research report, MITRE Center for Enterprise Modernization McLean, Va., April 2006) provides an overview of the features and functions of major commercial electronic health records.

“HIMSS Electronic Health Record Definitional Model Version 1.1” by HIMSS Electronic Health Record Committee (a report, 24 Sep., 2003) describes an operational EHR definition and key attributes to support the measurement of the penetration of electronic health records in health systems.

“Archetypes—Constraint-based Domain Models for Futureproof Information Systems” by Beale; Thomas (appeared as a report, www.deepthought.com.au, 21 Aug. 2001) describes a formal language for archetypes for modeling and describing electronic health records.

The known systems do not address the issue of systematically gathering of person-centric health records, structuring and correlating of these records leading to the achieving of high level of health consciousness and distributability of the heath records. The present invention provides for a system and method for personal healthcare analysis and distributable archiving.

### SUMMARY OF THE INVENTION

The primary objective of the invention is to build a person-centric health records to help enhance effective healthcare and increase health consciousness in an individual.

One aspect of the present invention is to be able to distribute the archived personal health records of the individual to multiple stakeholders.

Another aspect of the present invention is to manage the personal health records along six dimensions, namely, Accident (A), Disease (D), Environment (E), Narration (N), Observation (O), and Lifestyle (L).

Yet another aspect of the present invention is to further identify sub-dimensions of each of the six dimensions.

Another aspect of the present invention is to structure the personal health records of the individual along the six dimensions and sub-dimensions based on health related activities, actions, and events associated with the individual.

Yet another aspect of the present invention is to relate the raw input from multiple sources to generate dimension mapped data.

Another aspect of the present invention is to correlate the dimension mapped data to generate dimension linked data.

Yet another aspect of the present invention is to discover meta-dimension data based on the dimension linked data.

Another aspect of the present invention is to use support knowledge sources.

Yet another aspect of the present invention is use the notion of actflows in the generation of dimension linked data.

Another aspect of the present invention is to use the notion of autoflows in the generation of dimension linked data.

Yet another aspect of the present invention is to generate sequences of personal heath records based on actflows and autoflows.

Another aspect of the present invention is to assign a label for the generated sequence.

Yet another aspect of the present invention is to generate clusters of personal health records based on autoflows.

Another aspect of the present invention is to use the notion of link dimensions as part of the autoflows.

Yet another aspect of the present invention is to generate meta-clusters based on labeled sequences and clusters.

Another aspect of the present invention is to use the notion of set-theoretic operators, metaflows and auto-discovery in the generation of meta-sequences and meta-clusters.

In a preferred embodiment the present invention provides a system for analysis of and distributable archiving of a plurality of personal health records in a personal health database of a person based on a plurality of health related activities, a plurality of health related events, and a plurality of health related actions associated with said person, resulting in a plurality of sequences of said personal health records, a plurality of clusters of said personal health records, a plurality of meta-sequences of said plurality of sequences, and a plurality of meta-clusters of said plurality of clusters and said plurality of sequences, said system comprising:
means for obtaining a plurality of raw data records based on said plurality of health related activities, said plurality of health related events, and said plurality of health related actions, and for making of said plurality raw data records as a part of said personal health database;
means for obtaining of a plurality of dimensions comprising of an accident dimension, a disease dimension, an environment dimension, a narration dimension, an observation dimension, and a lifestyle dimension, and for obtaining of a plurality of sub-dimensions for each of said plurality of dimensions,
means for relating of said plurality of raw data records into a plurality of dimension mapped records, wherein a record dimension of a dimension mapped record of said plurality of dimension mapped records is a dimension of said plurality of dimensions and a sub-dimension of a plurality of sub-dimensions associated with said dimension, and for making of said plurality of dimension mapped records a part of said personal health database;
means for correlating of said plurality of dimension mapped records to generate a plurality of dimension linked records, wherein a dimension linked record of said plurality of dimension linked records is a sequence of said plurality of personal health records of said personal health database, wherein said sequence is a part of said plurality of sequences or a cluster of said plurality of personal health records of said personal health database, wherein said cluster is a part of said plurality of clusters, and for making of said plurality of dimension linked records a part of said personal health database; and
means for discovering a plurality of meta-dimension records based on said plurality of sequences and said plurality of clusters resulting in a plurality of meta-dimension records, wherein a meta-dimension record of said plurality of meta-dimension records is a meta-sequence of said plurality of sequences, wherein said meta-sequence is a part of said plurality meta-sequences or a meta-cluster of said plurality of clusters, wherein said meta-cluster is a part of said plurality of meta-clusters, and for making of said plurality of meta-dimension records a part of said personal health database.
(BASED ON FIGS. 1, 2, 2A, 3, and 3A)

### BRIEF DESCRIPTION OF THE DRAWINGS

FIG. 1 describes the overall Positioning of pHANDA System.

FIG. 2 describes briefly the Multiple Dimensions of pHANDA System.

FIG. 2A provides an illustrative list of Sub-Dimensions.

FIG. 3 provides an overview of pHANDA System.

FIG. 3A provides a flow description of pHANDA System.

FIG. 4 provides an illustrative list of Sources of raw Data.

FIG. 4A provides an illustrative Dimension Mapping.

FIG. 4B depicts an illustrative Flow of Data Acquisition.

FIG. 5 provides an Approach for Dimension Mapping.

FIG. 5A provides additional information related to the Approach for Dimension Mapping.

FIG. 5B provides some more information related to the Approach for Dimension Mapping.

FIG. 6 provides an illustrative Mapped Data-Accident Dimension.

FIG. 6A provides an illustrative Mapped Data-Disease Dimension.

FIG. 6B provides an illustrative Mapped Data-Environment Dimension.

FIG. 6C provides an illustrative Mapped Data-Narration Dimension.

FIG. 6D provides an illustrative Mapped Data-Observation Dimension.

FIG. 6E provides an illustrative Mapped Data-LifeStyle Dimension.

FIG. 7 depicts approaches for Linking across Dimensions.

FIG. 7A provides an approach for obtaining an ActFlow.

FIG. 7B provides an ActFlow based approach for Linking across Dimensions.

FIG. 7C provides an AutoFlow based Approach for Linking across Dimensions.

FIG. 7D provides additional information related to the AutoFlow based Approach for Linking across Dimensions.

FIG. 8 depicts an illustrative ActFlow.

FIG. 8A depicts an illustrative Sequence.

FIG. 9 describes an approach for Discovery.

FIG. 9A provides an approach for obtaining a Meta Flow.

FIG. 9B describes additional approaches for Discovery.

FIG. 10 depicts an illustrative Meta-Cluster.

FIG. 10A depicts an illustrative Meta Flow.

FIG. 10B provides an illustration of Discovery-Abstraction (similarity measure based).

FIG. 10C depicts an illustration of Label Hierarchy.

### DETAILED DESCRIPTION OF THE PREFERRED EMBODIMENTS

An individual gets involved in a large volume of healthcare related transactions that ever grows with time. Right from birth, there are several activities by an individual or related to the individual leading to health related actions and events. With time, these activities, actions, and events would have much impact on the well being of the individual as future activities can be well guided if the past activities are well tracked: the need is to collect and organize these voluminous transactions so that most of the queries regarding the health of the individual get answered in the most appropriate manner. Consider the following scenario: a person meets with an accident and is brought to the hospital in the semi-conscious state; the physician handling the patient needs to understand the allergic characteristics of the patient so that proper treatment can be administered. How to answer this question as quickly as possible and as accurately as possible as the patient needs to be treated immediately? The proposed invention addresses this and many such instances.

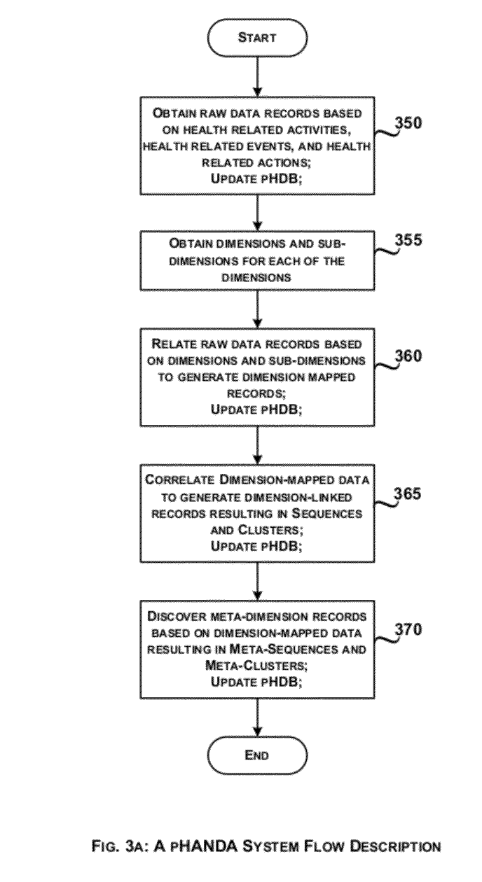

The steps illustrated in FIGS. 3A, 4B, 5, 5A, 5B, 7A, 7B, 7C, 9, 9A and 9B also refer to the corresponding “means” of the system of the present invention for carrying out the relevant steps.

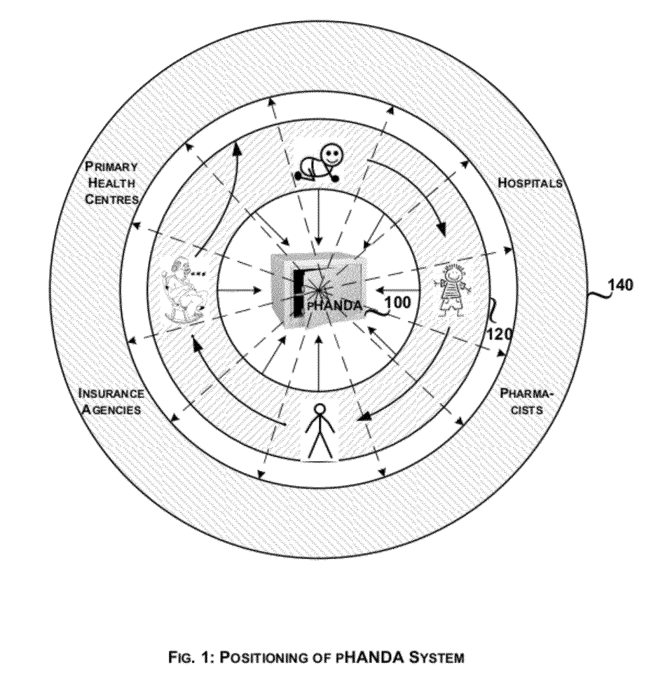

FIG. 1 describes the overall Positioning of pHANDA System. At the heart of the system is the well-protected archived information about the individual (personal/self) (100). The various data that get generated due to the activities of the individual get stored for analysis and distribution purposes. Note that while the archive is distributable, the distribution itself is outside the scope of the present invention: it is supposed that the process of distribution indeed protects the rights of the individual and is based upon the laws of the land. The gathered data is over a period of time and longer this period, more large scale is the extent of analysis and more accurate is the conclusion drawn based on the analysis of the archived data. The figure depicts an ideal situation wherein data gets collected right from birth and systematically afterwards (120). Indeed such a collection provides a digital footprint of the individual highlighting what happened when and why from health point of view. Notice from FIG. 1 that the archived and analyzed data address the needs of the various stakeholders: physicians, nurses, hospital administrators, pharmacists, primary health centers, and insurance agencies (140). At any point in time, these stakeholders are required to query the pHANDA system so that their decisions with respect to the individual are well based.

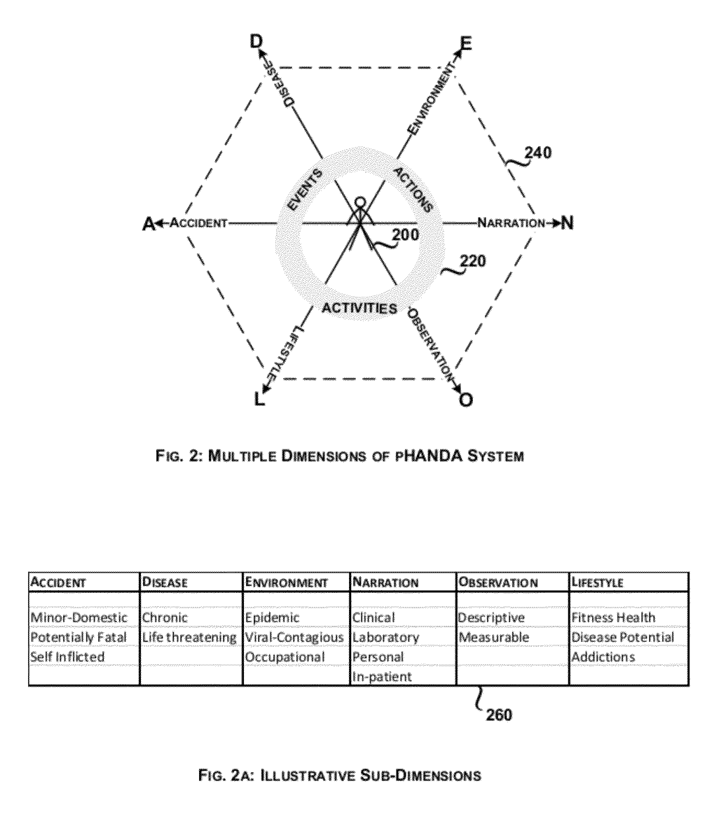

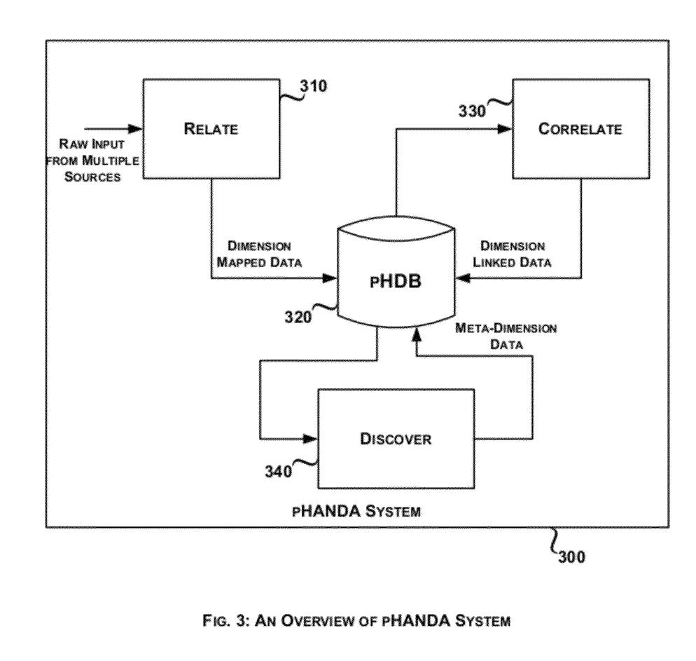

FIG. 2 describes briefly the Multiple Dimensions of pHANDA System. The systematic archiving of the large volume of health related records of the individual needs an approach of categorizing of the data. An individual (200) is involved in a variety of activities leading to actions and events (220). This forms the basic or raw data that need to be archived. The archiving is based on the proposed following six dimensions (240): Accident (A), Disease (D), Environment (E), Narration (N), Observation (O), and Lifestyle (L). These dimensions are expected to be comprehensive and exhaustive in the sense that all of the activities, actions, and the events of and related to the individual get mapped onto one or more of these six dimensions and thereby helping in the process of structuring of raw data. A brief about these dimensions is provided below:

Accident (A) dimension: This dimension captures the data related to accidents met by the individual—minor, domestic, major, road, etc.

Disease (D) dimension: This dimension captures the data related to the various diseases suffered by the individual—simple, chronic, etc.

Environment (E) dimension: This dimension captures the data related to the environment in which the individual lives; note that a systematic analysis of this data is very useful in certain cases for effective diagnosis and also for addressing the well being of the individual.

Narration (N) dimension: This dimension captures data narrated by the individual related to such as pain or sensation.

Observation (O) dimension: This dimension captures data related to such as the various tests performed at labs by technicians.

Lifestyle (L) dimension: This dimension captures data related to the lifestyle related activities of a person such as fitness information.

FIG. 2A provides an illustrative list of Sub-Dimensions. The following provides an illustrative list of sub-dimensions for each of the dimensions (260):

Dimension: Accident (A)

Sub-dimension examples: Minor-Domestic, Potentially Fatal, and Self Inflicted;

Dimension: Disease (D)

Sub-dimension examples: Chronic and Life threatening;

Dimension: Environment (E)

Sub-dimension examples: Epidemic, Viral-Contagious, and Occupational;

Dimension: Narration (N)

Sub-dimension examples: Clinical, Laboratory, Personal, and In-patient;

Dimension: Observation (O)

Sub-dimension examples: Descriptive and Measurable;

Dimension: Lifestyle (L)

Sub-dimension examples: Fitness Health, Disease Potential, and Addictions;

While the six dimensions provide the first level structuring of raw data, the sub-dimensions provide additional structuring of the raw data.

FIG. 3 provides an Overview of pHANDA System. The main objectives of the pHANDA system (300) are to gather as much health related information about an individual as possible, catalog the information in a structured manner, analyze the structured information to derive certain meta-information (analysis), and provide the structured information to the various stakeholders (distribution). The raw data obtained from several sources are analyzed and are mapped one or more of the six dimensions, namely, A, D, E, N, O, and/or L (310). This process is called as “Relate” wherein the raw data records are mapped onto the pre-defined six dimensions. The dimension mapped structured data is called as personal Health Records (pHRs) and are updated onto personal Healthcare database (pHDB) (320). Note raw input from multiple sources is also part of the pHDB. The next step is to analyze the pHRs to establish links across the pHRs in the multiple six dimensions: this process is called as “Correlate” (330) and the dimension linked data are updated onto pHDB. The final step is to analyze the related and correlated pHRs to determine meta-information and this process is called as “Discover” (340) and this meta-dimension data are also updated onto phDB.

FIG. 3A provides a flow description of pHANDA System.

The means for achieving the overall objective of pHANDA system is provided below.

Obtain raw data records based on health related activities, health related events, and health related actions (350); and Update pHDB. Note that these raw data records are input into the system.

Obtain dimensions and sub-dimensions for each of the dimensions (355). Relate raw data records based on dimensions and sub-dimensions to generate dimension mapped records (360); and Update pHDB. Correlate Dimension-mapped data to generate dimension-linked records resulting in Sequences and Clusters (365); and Update pHDB. And finally, Discover meta-dimension records based on dimension-mapped data resulting in Meta-Sequences and Meta-Clusters (370); and Update pHDB.

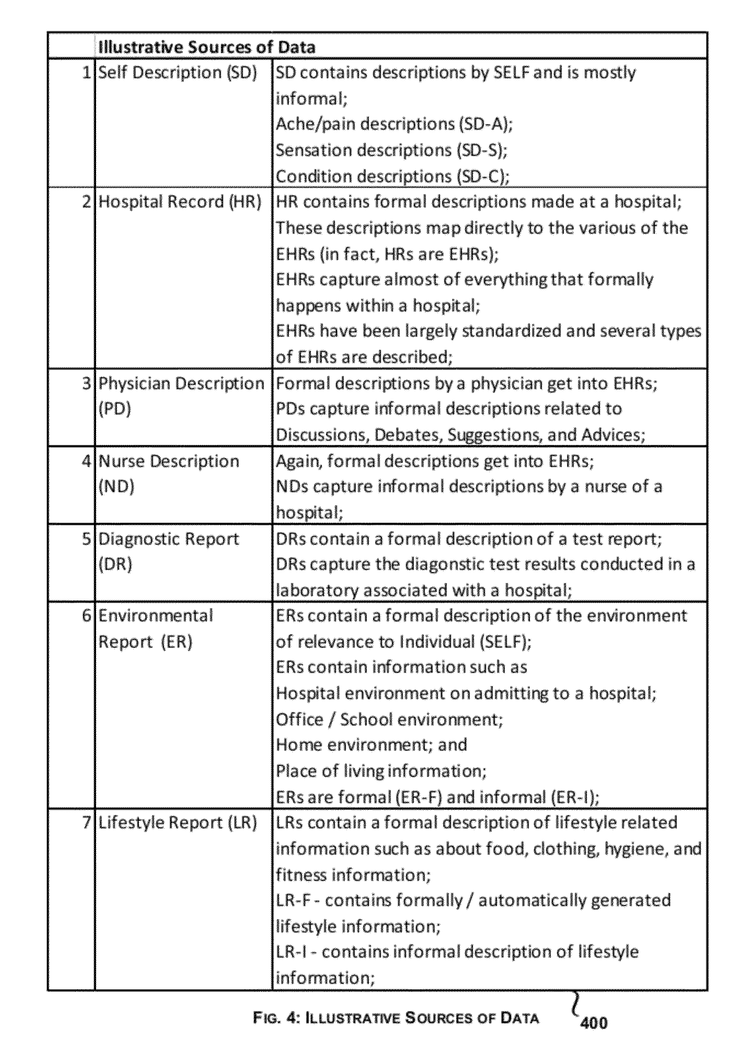

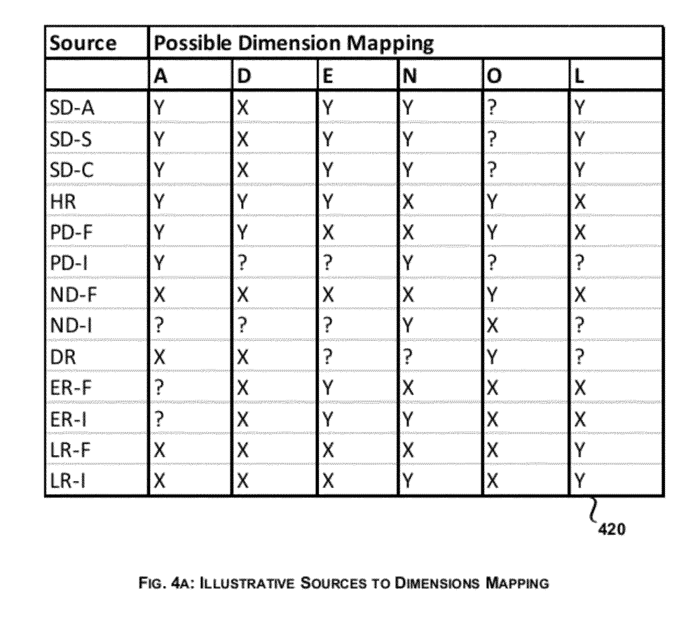

FIG. 4 provides an illustrative list of Sources of raw Data. The table (400) depicts the means for obtaining of data related to seven illustrative raw sources:

Illustrative Sources of Data

1 Self Description (SD)
SD contains descriptions by SELF and is mostly informal;
Ache/pain descriptions (SD-A);
Sensation descriptions (SD-S);
Condition descriptions (SD-C);

2 Hospital Record (HR)
HR contains formal descriptions made at a hospital;
These descriptions map directly to the various of the Electronic Health Records (EHRs) (in fact, HRs are EHRs);
EHRs capture almost of everything that formally happens within a hospital;
EHRs have been largely standardized and several types of EHRs are described;

3 Physician Description (PD)
Formal descriptions by a physician get into EHRs;
PDs capture informal descriptions related to Discussions, Debates, Suggestions, and Advices;

4 Nurse Description (ND)
Again, formal descriptions get into EHRs;
NDs capture informal descriptions by a nurse of a hospital;

5 Diagnostic Report (DR)
DRs contain a formal description of a test report;
DRs capture the diagnostic test results conducted in a laboratory associated with a hospital;

6 Environmental Report (ER)
ERs contain a formal description of the environment of relevance to Individual (SELF);
ERs contain information such as
Hospital environment on admitting to a hospital;
Office/School environment;
Home environment; and
Place of living information;
ERs are formal (ER-F) and informal (ER-I);

7 Lifestyle Report (LR)
LRs contain a formal description of lifestyle related information such as about food, clothing, hygiene, and fitness information;
LR-F—contains formally/automatically generation lifestyle information;
LR-I—contains informal description of lifestyle information;

FIG. 4A provides an illustrative Dimension Mapping. The table (420) depicts an illustrative mapping of sources of data to the various dimensions. Note that “Y” indicates a sure map while “X” indicates that mapping is impossible. Further, a “?” indicates a possibility of a mapping. This table gets used in Relate to effectively map the vague, ambiguous raw data to one or more of the six dimensions.

Source Possible Dimension Mapping:

SD-A: A(Y), D(X), E(Y), N(Y), O(?), and L(Y);

SD-S: A(Y), D(X), E(Y), N(Y), O(?), and L(Y);

SD-C: A(Y), D(X), E(Y), N(Y), O(?), and L(Y);

HR: A(Y), D(Y), E(X), N(X), O(Y), and L(X);

PD-F: A(Y), D(Y), E(X), N(X), O(Y), and L(X);

PD-I: A(Y), D(?), E(?), N(Y), O(?), and L(?);

ND-F: A(X), D(X), E(X), N(X), O(Y), and L(X);

ND-I: A(?), D(?), E(?), N(Y), O(X), and L(?);

DR: A(X), D(X), E(?), N(?), O(Y), and L(?);

ER-F: A(?), D(X), E(Y), N(X), O(X), and L(X);

ER-I: A(?), D(X), E(Y), N(Y), O(X), and L(X);

LR-F: A(X), D(X), E(X), N(X), O(X), and L(Y);

LR-I: A(X), D(X), E(X), N(Y), O(X), and L(Y);

FIG. 4B depicts an illustrative Flow of Data Acquisition.

The means for obtaining a plurality of raw data records is provided below.

Obtain a self-description data record based on health related activities, health related events, and health related actions (450); and Update pHDB. Note that such self-description records are input into the system.

Obtain a hospital data record based on health related activities, health related events, and health related actions (455); and Update pHDB.

Obtain a physician description data record based on health related activities, health related events, and health related actions (460); and Update pHDB.

Obtain a nurse description data record based on health related activities, health related events, and health related actions (465); and Update pHDB.

Obtain a diagnostic description data record based on health related activities, health related events, and health related actions (470); and Update pHDB.

Obtain an environmental description data record based on health related activities, health related events, and health related actions (475); and Update pHDB.

Obtain a lifestyle description data record based on health related activities, health related events, and health related actions (480); and Update pHDB.

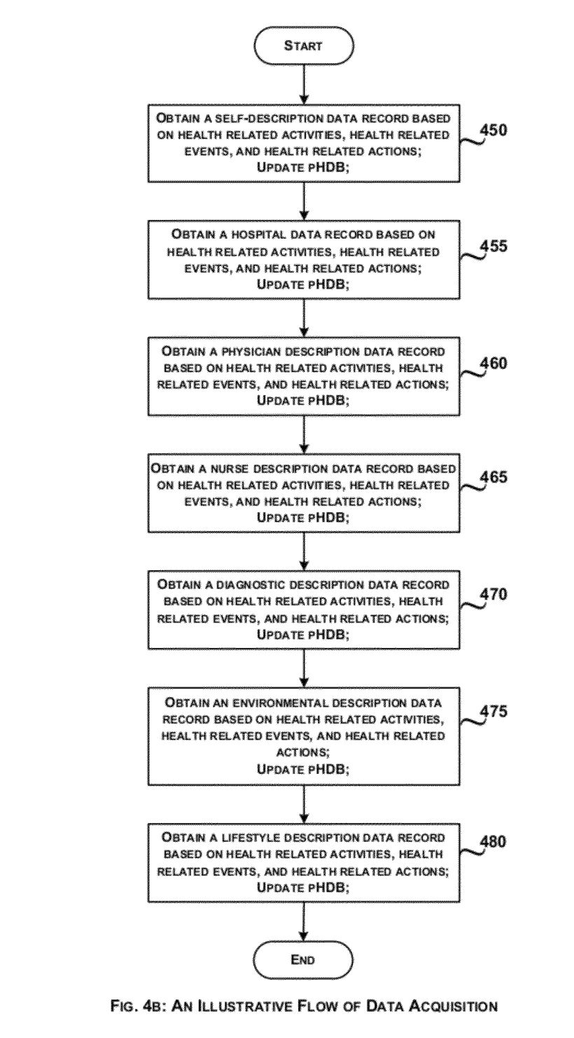

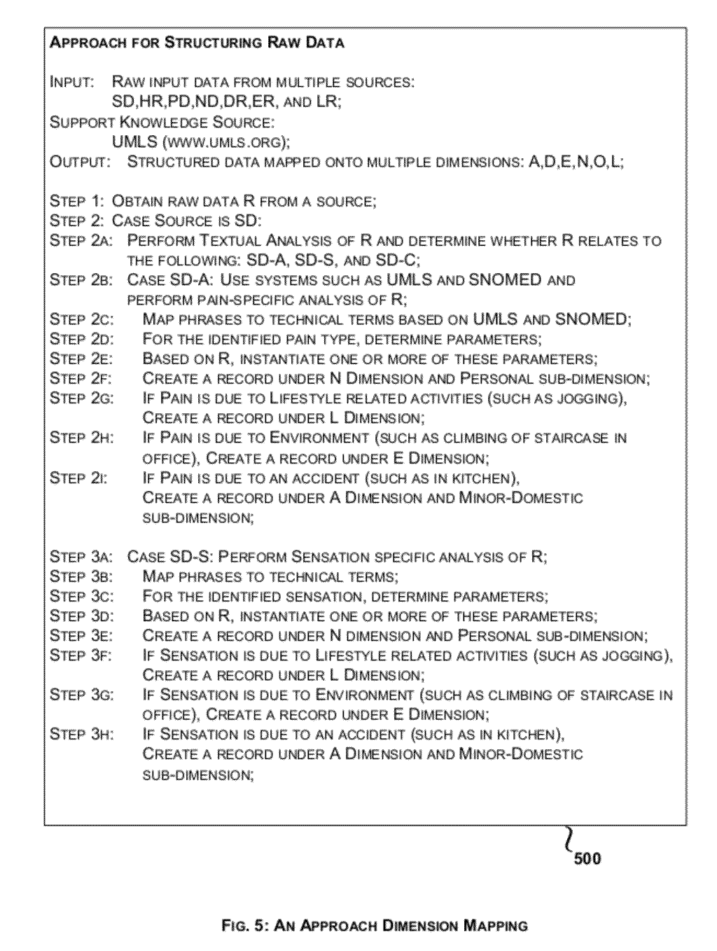

FIG. 5 provides an Approach for Dimension Mapping.

Means for (“relating”) an approach for Structuring Raw Data (500):

Input: Raw input data from multiple sources:
SD,HR,PD,ND,DR,ER, and LR;

Support Knowledge Source:
UMLS (www.umls.org);

Output: Structured data mapped onto multiple dimensions: A,D,E,N,O,L;
Step 1: Obtain raw data R from a source;
Step 2: Case Source is SD:
Step 2a: Perform Textual Analysis of R and determine whether R relates to the following:
   SD-A, SD-S, and SD-C;
Step 2b: Case SD-A: Use systems such as UMLS and SNOMED and
   perform pain-specific analysis of R;
Step 2c: Map phrases to technical terms based on UMLS and SNOMED;
Step 2d: For the identified pain type, determine parameters;
Step 2e: Based on R, instantiate one or more of these parameters;
Step 2f: Create a record under N Dimension and Personal sub-dimension;
Step 2g: If Pain is due to Lifestyle related activities (such as jogging),
   Create a record under L Dimension;
Step 2h: If Pain is due to Environment (such as climbing of staircase in office),
   Create a record under E Dimension;
Step 2i: If Pain is due to an accident (such as in kitchen),
   Create a record under A Dimension and Minor-Domestic sub-dimension;
Step 3a: Case SD-S: Perform Sensation specific analysis of R;
Step 3b: Map phrases to technical terms;
Step 3c: For the identified sensation, determine parameters;
Step 3d: Based on R, instantiate one or more of these parameters;
Step 3e: Create a record under N dimension and Personal sub-dimension;
Step 3f: If Sensation is due to Lifestyle related activities (such as jogging),
   Create a record under L Dimension;
Step 3g: If Sensation is due to Environment (such as climbing of staircase in office),
   Create a record under E Dimension;
Step 3h: If Sensation is due to an accident (such as in kitchen),
   Create a record under A Dimension and Minor-Domestic sub-dimension;

FIG. 5A provides additional information related to the Approach for Dimension Mapping.

Means (“relating”) for an approach for Structuring Raw Data (Contd.) (520):
Step 4: Case SD-C: Perform Condition specific analysis of R;
Step 4a: Map phrases to technical terms;
Step 4b: For the identified Condition, determine parameters;
Step 4c: Based on R, instantiate one or more of these parameters;
Step 4d: Create a record under N dimension and Personal sub-dimension;
Step 4e: If Condition is due to Lifestyle related activities (such as jogging),
   Create a record under L Dimension;
Step 4f: If Condition is due to Environment (such as climbing of staircase in office),
   Create a record under E Dimension;
Step 4g: If Condition is due to an accident (such as in kitchen),
   Create a record under A Dimension and Minor-Domestic sub-dimension;
Step 5: Case source is HR:
Step 5a: Analyze R and determine the closest one or more standard EHRs;
Step 5b: Based on R, fill in the EHRs;
Step 5c: If an EHR of the EHRs is related to disease,
   Create a record under D Dimension;
Step 5d: If an EHR of the EHRs is related to a test report,
   Create a record under O Dimension;
Step 5e: If an EHR of the EHRs is related to an accident,
   Create a record under A Dimension;
Step 6: Case source is PD:
Step 6a Analyze R and determine whether R is a formal or informal description;
Step 6b: Case PD-F:
Step 6c: Based on R, determine the matching EHRs;
Step 6d: Based on type of each of the EHRs,
   Create an appropriate record under an appropriate dimension;
Step 6e: Case PD-I:
Step 6f: Perform textual analysis of R;
Step 6g: Map phrases to technical terms;
Step 6h: Create a record under N Dimension and say, Clinical sub-dimension;
Step 6i: If R is related to an accident,
   Create a record under A Dimension;

FIG. 5B provides some more information related to the Approach for Dimension Mapping.

Means (“relating”) for an approach for Structuring Raw Data (Contd.) (540):
Step 7: Case source is ND:
Step 7a Analyze R and determine whether R is a formal or informal description;
Step 7b: Case ND-F:
Step 7c: Based on R, determine the matching EHRs;
Step 7d: Based on type of each of the EHRs,
   Create an appropriate record under an appropriate dimension, say, under O Dimension;
Step 7e: Case ND-I:
Step 7f: Perform textual analysis of R;
Step 7g: Map phrases to technical terms;
Step 7h: Create a record under N Dimension and say, In-Patient sub-dimension;
Step 8: Case source is DR:
Step 8a: Based on R, determine the matching EHRs;
Step 8b: Based on type of each of the EHRs,
   Create an appropriate record under an appropriate dimension, say, under O Dimension;
Step 9: Case source is ER:
Step 9a Analyze R and determine whether R is a formal or informal description;
Step 9b: Case ER-F:
Step 9c: Based on R, determine the matching EHRs;
Step 9d: Based on type of each of the EHRs,
   Create an appropriate record under an appropriate dimension, say, under E Dimension;
Step 9e: Case ER-I:
Step 9f: Perform textual analysis of R;
Step 9g: Map phrases to technical terms;
Step 9h: Create a record under N Dimension;
Step 10: Case source is LR:
Step 10a Analyze R and determine whether R is a formal or informal description;
Step 10b: Case LR-F:
Step 10c: Based on R, determine the matching EHRs;
Step 10d: Based on type of each of the EHRs,
   Create an appropriate record under an appropriate dimension, say, under L Dimension;
Step 10e: Case LR-I:
Step 10f: Perform textual analysis of R;
Step 10g: Map phrases to technical terms;
Step 10h: Create a record under N Dimension;
Step 11: END.

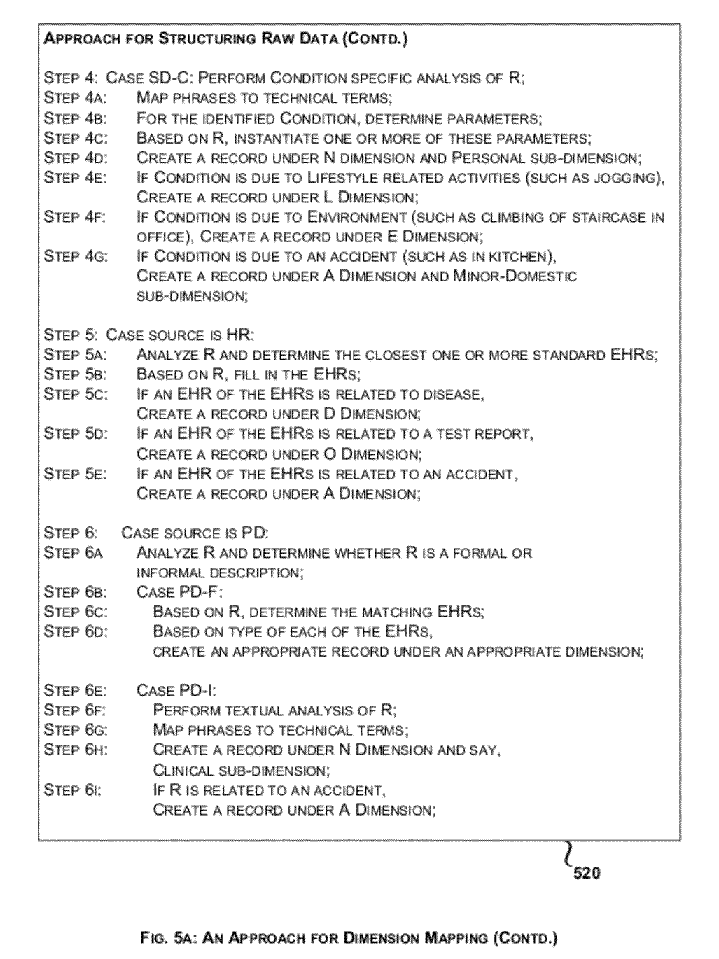

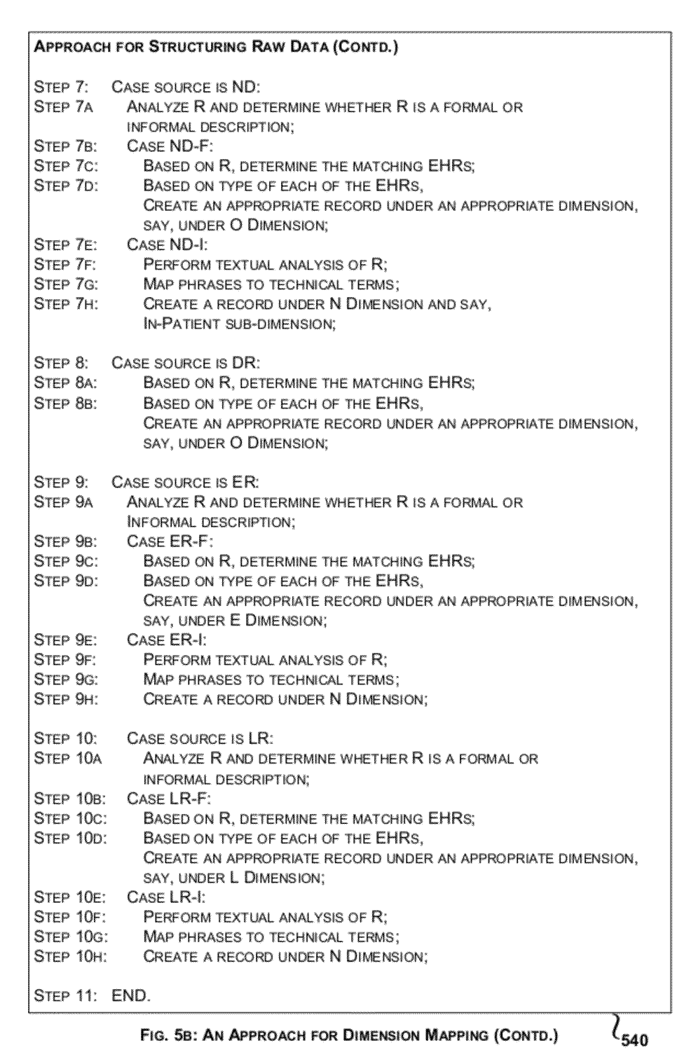

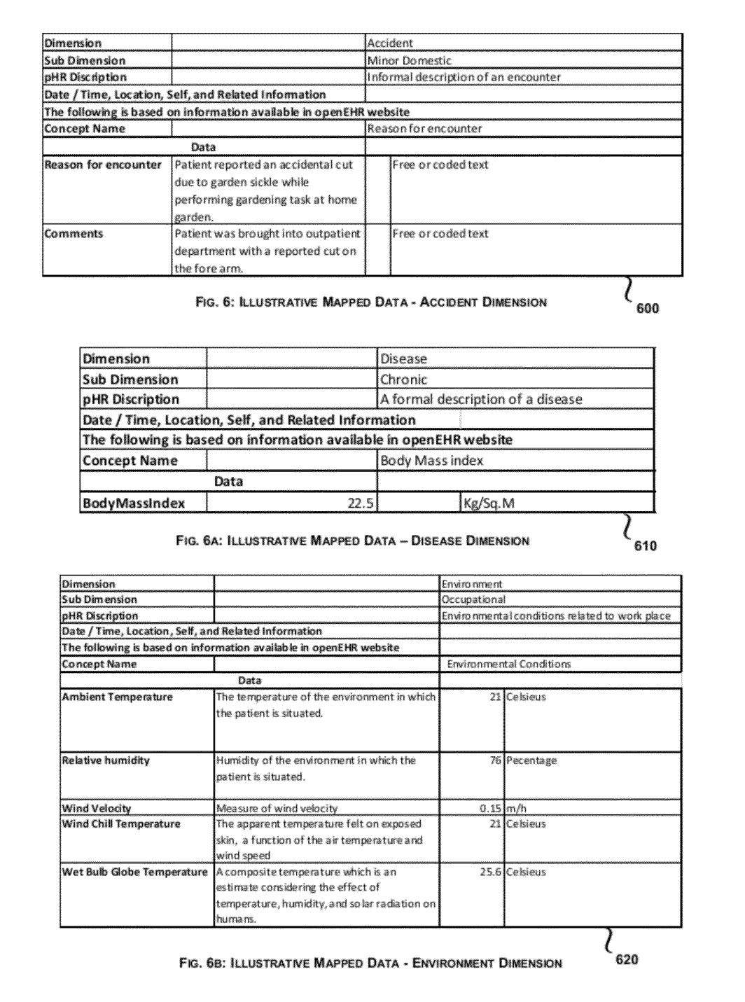

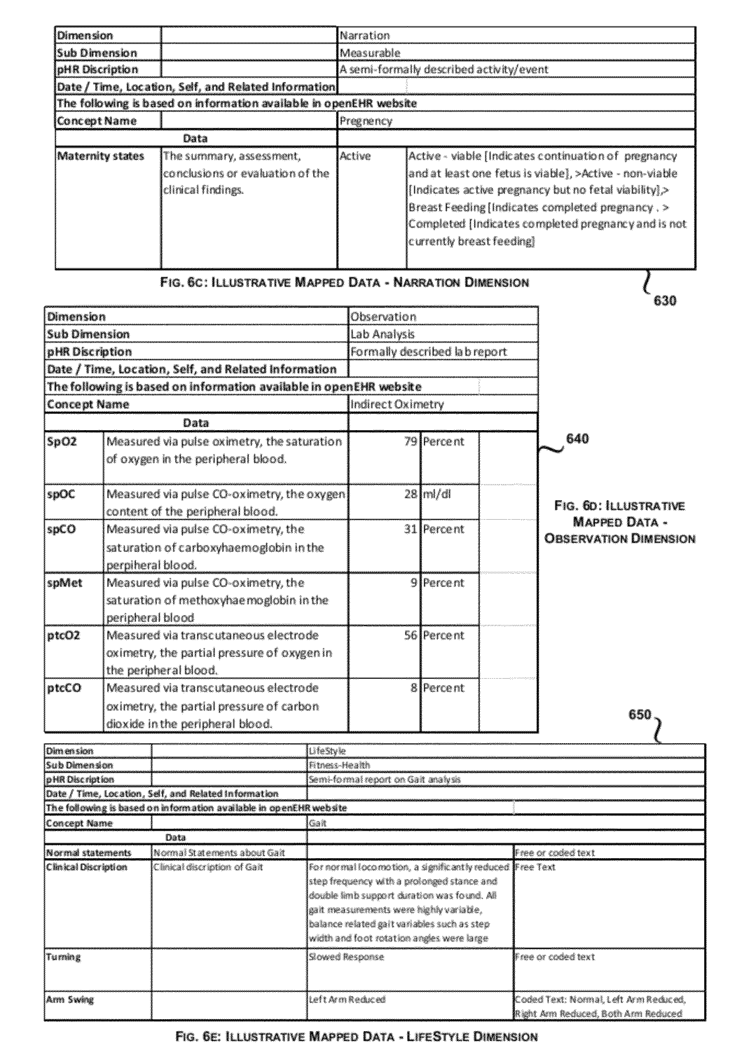

FIG. 6 provides an illustrative Mapped Data-Accident Dimension. The raw source data is analyzed to fill in the various fields of the A dimension pHR (600). Note that apart from the specific data, the pHR also contains the general data such as date/time, location, information about self, and other related information.

FIG. 6A provides an illustrative Mapped Data-Disease Dimension. The raw source data is analyzed to fill in the various fields of D dimension pHR (610).

FIG. 6B provides an illustrative Mapped Data-Environment Dimension. The raw source data is analyzed to fill in the various fields of E dimension pHR (620).

FIG. 6C provides an illustrative Mapped Data-Narration Dimension. The raw source data is analyzed to fill in the various fields of D dimension pHR (630).

FIG. 6D provides an illustrative Mapped Data-Observation Dimension. The raw source data is analyzed to fill in the various fields of O dimension pHR (640).

FIG. 6E provides an illustrative Mapped Data-LifeStyle Dimension. The raw source data is analyzed to fill in the various fields of L dimension pHR (650).

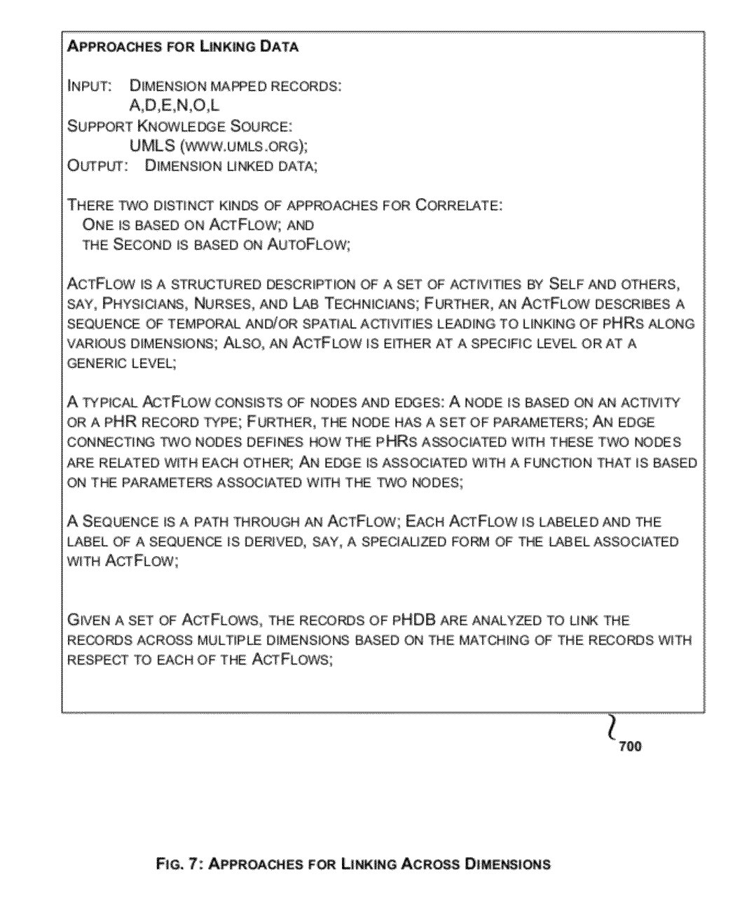

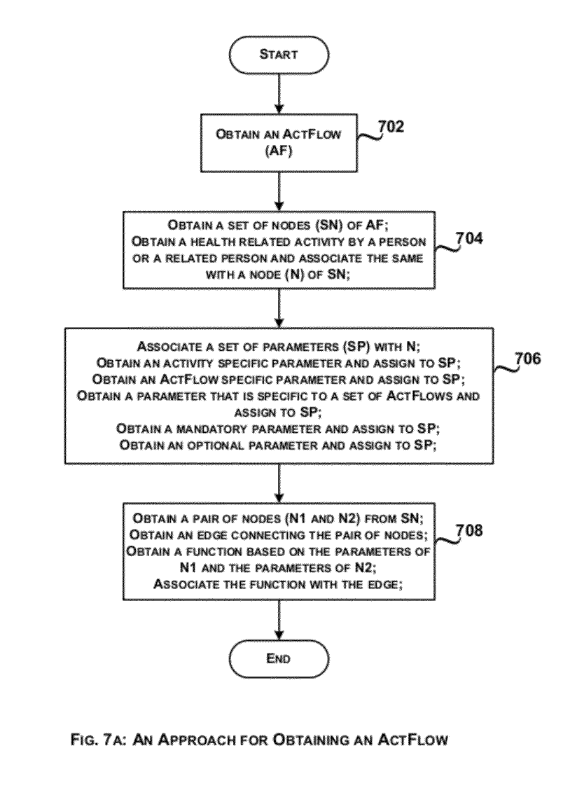

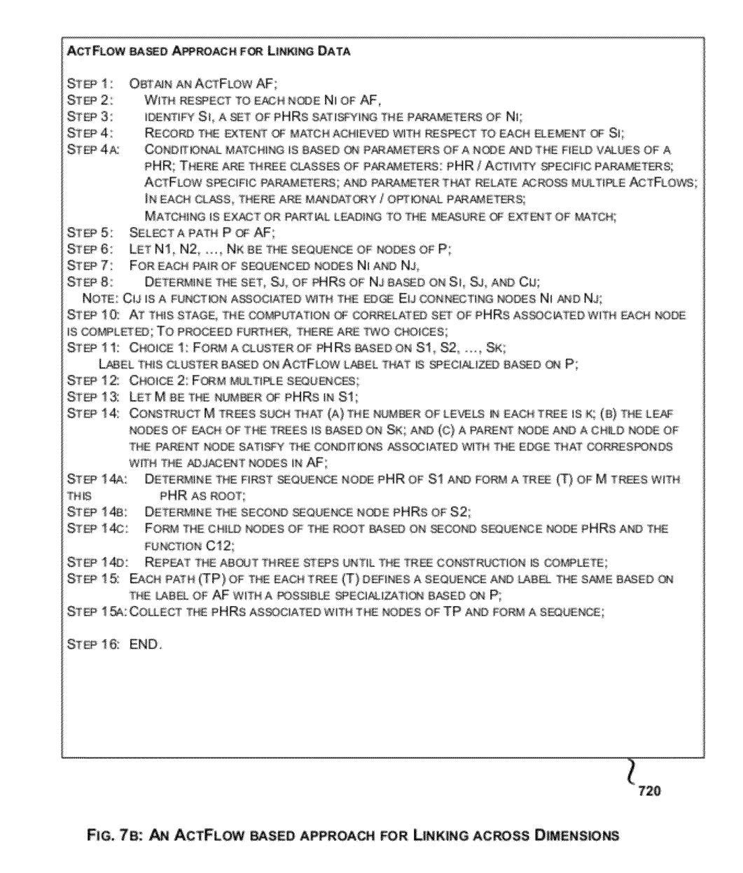

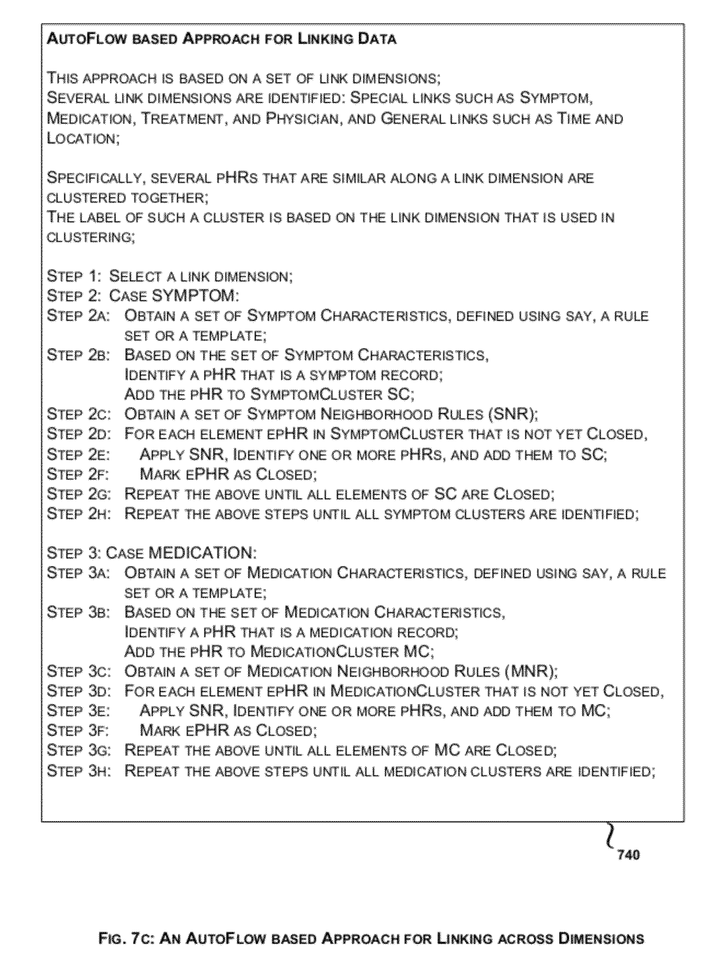

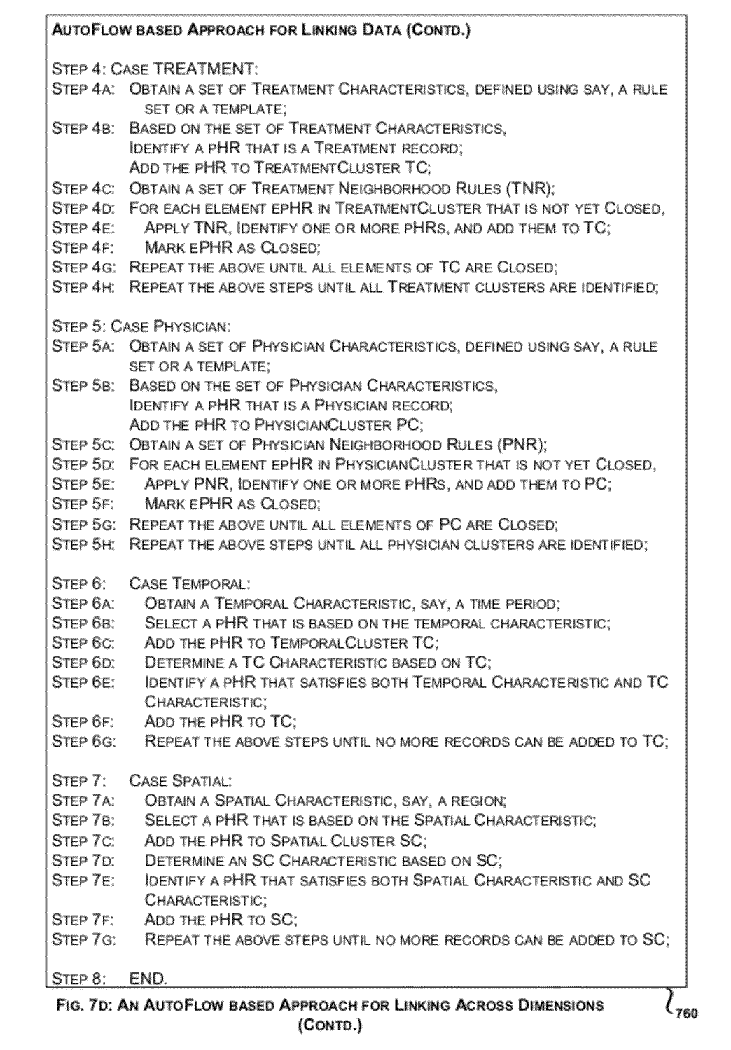

FIG. 7 depicts approaches for Linking across Dimensions.

Means for (“correlating”) approaches for Linking Data (700):

Input: Dimension mapped records:
A,D,E,N,O,L

Support Knowledge Source:
UMLS (www.umls.org);

Output: Dimension linked data;

There two distinct kinds of approaches for Correlate:
One is based on ActFlow; and
the Second is based on AutoFlow;

ActFlow is a structured description of a set of activities by Self and others, say, Physicians, Nurses, and Lab Technicians; Further, an ActFlow describes a sequence of temporal and/or spatial activities leading to linking of pHRs along various dimensions; Also, an ActFlow is either at a specific level or at a generic level;

A typical ActFlow consists of nodes and edges: A node is based on an activity or a pHR record type; Further, the node has a set of parameters; An edge connecting two nodes defines how the pHRs associated with these two nodes are related with each other; An edge is associated with a function that is based on the parameters associated with the two nodes;

A Sequence is a path through an ActFlow; Each ActFlow is labeled and the label of a sequence is derived, say, a specialized form of the label associated with ActFlow;

Given a set of ActFlows, the records of pHDB are analyzed to link the records across multiple dimensions based on the matching of the records with respect to each of the ActFlows;

FIG. 7A provides an approach for obtaining an ActFlow.

The means for obtaining of an actflow is provided below.

Obtain an ActFlow (AF) (720). Obtain a set of nodes (SN) of AF (704); and obtain a health related activity by a person or a related person and associate the same with a node (N) of SN. Associate a set of parameters (SP) with N (706); Obtain an activity specific parameter and assign to SP; Obtain an ActFlow specific parameter and assign to SP; Obtain a parameter that is specific to a set of ActFlows and assign to SP; Obtain a mandatory parameter and assign to SP; and Obtain an optional parameter and assign to SP. Obtain a pair of nodes (N1 and N2) from SN (708); Obtain an edge connecting the pair of nodes; Obtain a function based on the parameters of N1 and the parameters of N2; and associate the function with the edge.

FIG. 7B provides an ActFlow based approach for Linking across Dimensions.

Means for (“correlating”) ActFlow based Approach for Linking Data (720):
Step 1: Obtain an ActFlow AF;
Step 2: With respect to each node Ni of AF,
Step 3: identify Si, a set of pHRs satisfying the parameters of Ni;
Step 4: Record the extent of match achieved with respect to each element of Si;
Step 4a: Conditional matching is based on parameters of a node and the field values of a pHR;
   There are three classes of parameters: pHR/Activity specific parameters; ActFlow specific parameters; and parameter that relate across multiple ActFlows;
   In each class, there are mandatory/optional parameters; Matching is exact or partial leading to the measure of extent of match;
Step 5: Select a path P of AF;
Step 6: Let N1, N2, . . . , Nk be the sequence of nodes of P;
Step 7: For each pair of sequenced nodes Ni and Nj,
Step 8: Determine the set, Sj, of pHRs of Nj based on Si, Sj, and Cij;
   Note: Cij is a function associated with the edge Eij connecting nodes Ni and Nj;
Step 10: At this stage, the computation of correlated set of pHRs associated with each node is completed; To proceed further, there are two choices;
Step 11: Choice 1: Form a cluster of pHRs based on S1, S2, . . . , Sk; Label this cluster based on ActFlow label that is specialized based on P;
Step 12: Choice 2: Form multiple sequences;
Step 13: Let M be the number of pHRs in S1;
Step 14: Construct M trees such that (a) the number of levels in each tree is k; (b) the leaf nodes of each of the trees is based on Sk; and (c) a parent node and a child node of the parent node satisfy the conditions associated with the edge that corresponds with the adjacent nodes in AF;
Step 14a: Determine the first sequence node pHR of S1 and form a tree (T) of M trees with this pHR as root;
Step 14b: Determine the second sequence node pHRs of S2;
Step 14c: Form the child nodes of the root based on second sequence node pHRs and the function C12;
Step 14d: Repeat the about three steps until the tree construction is complete;
Step 15: Each path (TP) of the each tree (T) defines a sequence and label the same based on the label of AF with a possible specialization based on P;
Step 15a: Collect the pHRs associated with the nodes of TP and form a sequence;
Step 16: END.

FIG. 7C provides an AutoFlow based Approach for Linking across Dimensions.

Means (“correlating”) for AutoFlow based Approach for Linking Data (740):

This approach is based on a set of link dimensions;

Several link dimensions are identified: Special links such as Symptom, Medication, Treatment, and Physician, and General links such as Time and Location;

Specifically, several pHRs that are similar along a link dimension are clustered together;

The label of such a cluster is based on the link dimension that is used in clustering;
Step 1: Select a link dimension;
Step 2: Case SYMPTOM:
Step 2a: Obtain a set of Symptom Characteristics, defined using say, a rule set or a template;
Step 2b: Based on the set of Symptom Characteristics,
   Identify a pHR that is a symptom record;
   Add the pHR to SymptomCluster SC;
Step 2c: Obtain a set of Symptom Neighborhood Rules (SNR);
Step 2d: For each element epHR in SymptomCluster that is not yet Closed,
Step 2e: Apply SNR, Identify one or more pHRs, and add them to SC;
Step 2f: Mark ePHR as Closed;
Step 2g: Repeat the above until all elements of SC are Closed;
Step 2h: Repeat the above steps until all symptom clusters are identified;
Step 3: Case MEDICATION:
Step 3a: Obtain a set of Medication Characteristics, defined using say, a rule set or a template;
Step 3b: Based on the set of Medication Characteristics,
   Identify a pHR that is a medication record;
   Add the pHR to MedicationCluster MC;
Step 3c: Obtain a set of Medication Neighborhood Rules (MNR);
Step 3d: For each element epHR in MedicationCluster that is not yet Closed,
Step 3e: Apply SNR, Identify one or more pHRs, and add them to MC;
Step 3f: Mark ePHR as Closed;
Step 3g: Repeat the above until all elements of MC are Closed;
Step 3h: Repeat the above steps until all medication clusters are identified;

FIG. 7d provides additional information related to the AutoFlow based Approach for Linking across Dimensions.

Means (“correlating”) for AutoFlow based Approach for Linking Data (Contd.) (760):
Step 4: Case TREATMENT:
Step 4a: Obtain a set of Treatment Characteristics, defined using say, a rule set or a template;
Step 4b: Based on the set of Treatment Characteristics,
   Identify a pHR that is a Treatment record;
   Add the pHR to TreatmentCluster TC;
Step 4c: Obtain a set of Treatment Neighborhood Rules (TNR);
Step 4d: For each element epHR in TreatmentCluster that is not yet Closed,
Step 4e: Apply TNR, Identify one or more pHRs, and add them to TC;
Step 4f: Mark ePHR as Closed;
Step 4g: Repeat the above until all elements of TC are Closed;
Step 4h: Repeat the above steps until all Treatment clusters are identified;
Step 5: Case Physician:
Step 5a: Obtain a set of Physician Characteristics, defined using say, a rule set or a template;
Step 5b: Based on the set of Physician Characteristics,
   Identify a pHR that is a Physician record;
   Add the pHR to PhysicianCluster PC;
Step 5c: Obtain a set of Physician Neighborhood Rules (PNR);
Step 5d: For each element epHR in PhysicianCluster that is not yet Closed,
Step 5e: Apply PNR, Identify one or more pHRs, and add them to PC;
Step 5f: Mark ePHR as Closed;
Step 5g: Repeat the above until all elements of PC are Closed;
Step 5h: Repeat the above steps until all physician clusters are identified;
Step 6: Case Temporal:
Step 6a: Obtain a Temporal Characteristic, say, a time period;
Step 6b: Select a pHR that is based on the temporal characteristic;
Step 6c: Add the pHR to TemporalCluster TC;
Step 6d: Determine a TC Characteristic based on TC;
Step 6e: Identify a pHR that satisfies both Temporal Characteristic and TC Characteristic;
Step 6f: Add the pHR to TC;
Step 6g: Repeat the above steps until no more records can be added to TC;
Step 7: Case Spatial:
Step 7a: Obtain a Spatial Characteristic, say, a region;
Step 7b: Select a pHR that is based on the Spatial Characteristic;
Step 7c: Add the pHR to Spatial Cluster SC;
Step 7d: Determine an SC Characteristic based on SC;
Step 7e: Identify a pHR that satisfies both Spatial Characteristic and SC Characteristic;
Step 7f: Add the pHR to SC;
Step 7g: Repeat the above steps until no more records can be added to SC;
Step 8: END.

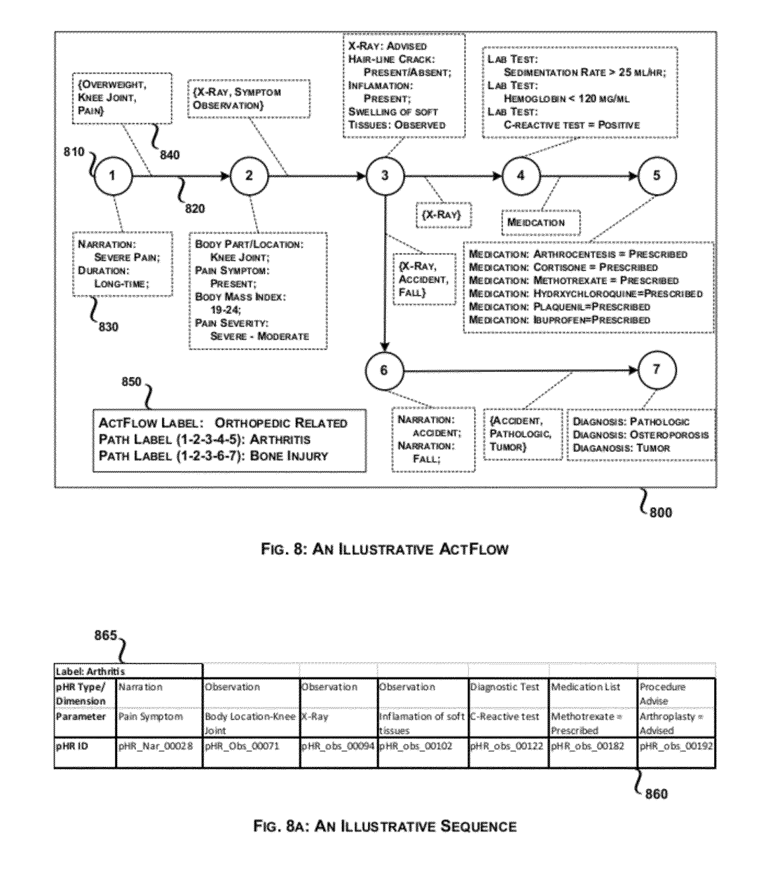

FIG. 8 depicts an illustrative ActFlow (800). Observe that an actflow consists of a set of nodes (node 1 (810), node 2, node 3, node 4, node 5, node 6, and node 7) and interconnected by edges as appropriate (edge 1-2 (820)). Each node is associated with a set of parameters (830) and similarly, each edge is associated with a set of parameters (840). Further, each actflow is associated with a label and where appropriate, select paths of an actflow are provided with a label (850).

FIG. 8A depicts an illustrative Sequence. Note that the sequence (860) is a sequence of pHRs that is based on a path of an actflow and satisfies that parameters associated with nodes and edges of the path. Furthermore, where appropriate, the sequence is provided with a label (865).

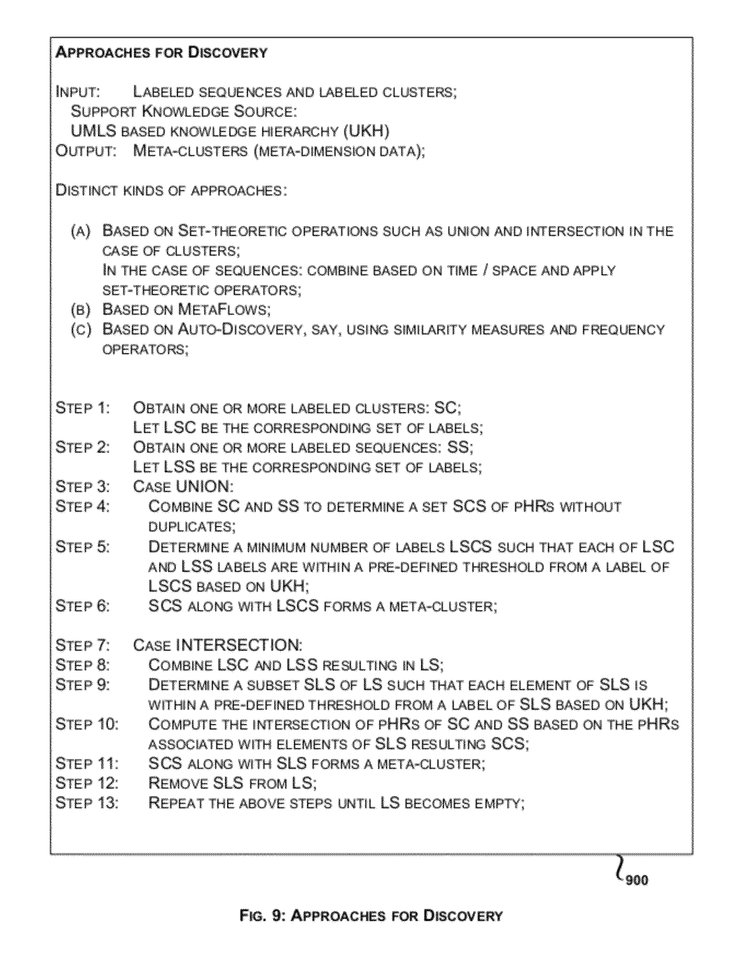

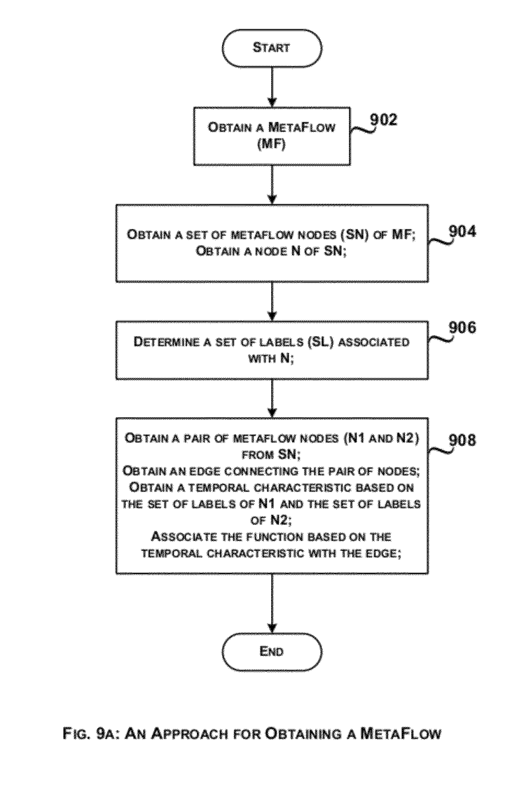

FIG. 9 describes an approach for Discovery.

Means (“discovering”) for approaches for Discovery (900):

Input: Labeled sequences and labeled clusters;
Support Knowledge Source:
UMLS based knowledge hierarchy (UKH)

Output: Meta-clusters (meta-dimension data);

Distinct kinds of approaches:
(a) Based on Set-theoretic operations such as union and intersection in the case of clusters;
   In the case of sequences: combine based on time/space and apply set-theoretic operators;
(b) Based on MetaFlows;
(c) Based on Auto-Discovery, say, using similarity measures and frequency operators;
Step 1: Obtain one or more labeled clusters: SC;
   Let LSC be the corresponding set of labels;
Step 2: Obtain one or more labeled sequences: SS;
   Let LSS be the corresponding set of labels;
Step 3: Case UNION:
Step 4: Combine SC and SS to determine a set SCS of pHRs without duplicates;
Step 5: Determine a minimum number of labels LSCS such that each of LSC and LSS labels are within a pre-defined threshold from a label of LSCS based on UKH;
Step 6: SCS along with LSCS forms a meta-cluster;
Step 7: Case INTERSECTION:
Step 8: Combine LSC and LSS resulting in LS;
Step 9: Determine a subset SLS of LS such that each element of SLS is within a pre-defined threshold from a label of SLS based on UKH;
Step 10: Compute the intersection of pHRs of SC and SS based on the pHRs associated with elements of SLS resulting SCS;
Step 11: SCS along with SLS forms a meta-cluster;
Step 12: Remove SLS from LS;
Step 13: Repeat the above steps until LS becomes empty;

FIG. 9A provides an approach for obtaining a MetaFlow.

The means for obtaining a metaflow is provided below.

Obtain a MetaFlow (MF) (902). Obtain a set of metaflow nodes (SN) of MF (904); and Obtain a node N of SN. Determine a set of labels (SL) associated with N (906). Obtain a pair of metaflow nodes (N1 and N2) from SN (908); Obtain an edge connecting the pair of nodes; Obtain a temporal characteristic based on the set of labels of N1 and the set of labels of N2; and Associate the function based on the temporal characteristic with the edge.

FIG. 9B describes additional approaches for Discovery.

Means (“discovering”) for approaches for Discovery (Contd.) (920):

MetaFlow defines a meta-sequence of sequences;

Each meta-node of a MetaFlow defines a label or a set of labels;

The edge of a metaFlow relates to connecting labels (meta-nodes) temporally;

The MetaFlow also defines a set of rules for relating the associated pHRs;
Step 14: Obtain a meta Flow MF;
Step 15: Determine a path P of MF;
Step 16: For each meta-node in P,
Step 17: Obtain the associated set SL of Labels;
Step 18: Determine the set of pHRs wherein, each of the pHRs is associated with a label of SL;
Step 19: Add this set of pHRs to MetaSet;

Note: MetaSet is a set of sets;
Step 20: Obtain RuleSet associated with MF;
Step 21: Apply RuleSet on MetaSet to determine Meta-Cluster;

Note: Meta-Cluster defines a meta-sequence based on MF;
Step 22: Associate the label of MF as the label of Meta-Cluster;

Auto Discovery:

Determines meta-sequences/meta-clusters based on a set of unsupervised techniques;
Step 23: Obtain a sequence or a cluster CS (seed);
Step 24: Obtain the label LCS corresponding with CS;
Step 25: Determine sequences and clusters, SCS, that are similar to CS based on a similarity measure, LCS, UKH, and a pre-defined threshold;
Step 26: Combine SCS to determine Meta-Cluster;
Step 27: Based on the labels associated with the elements of Meta-Cluster, determine the label for Meta-Cluster;
Step 28: END.

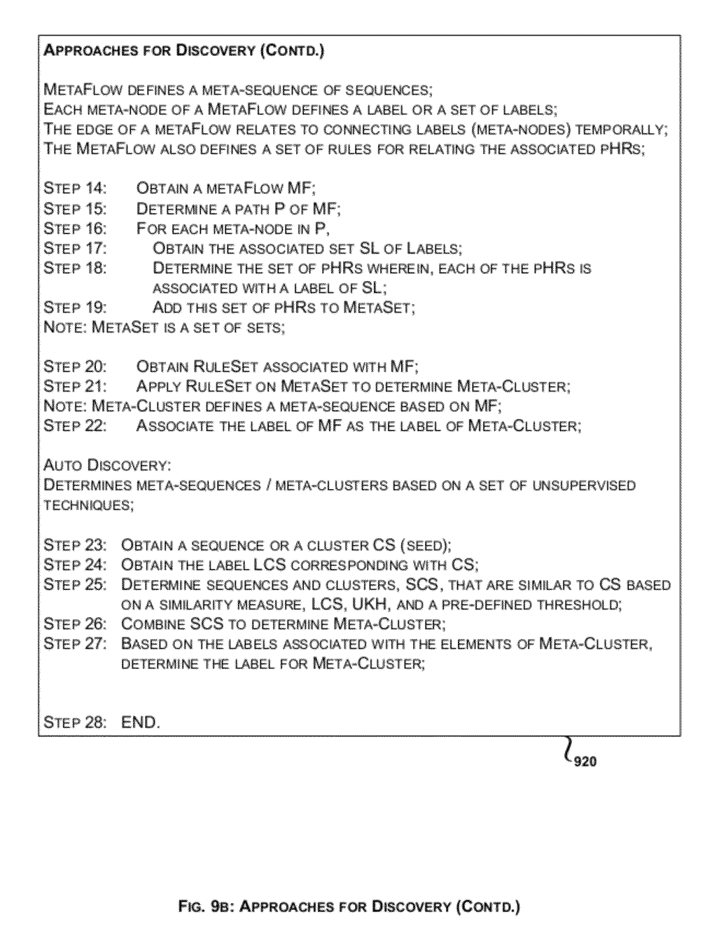

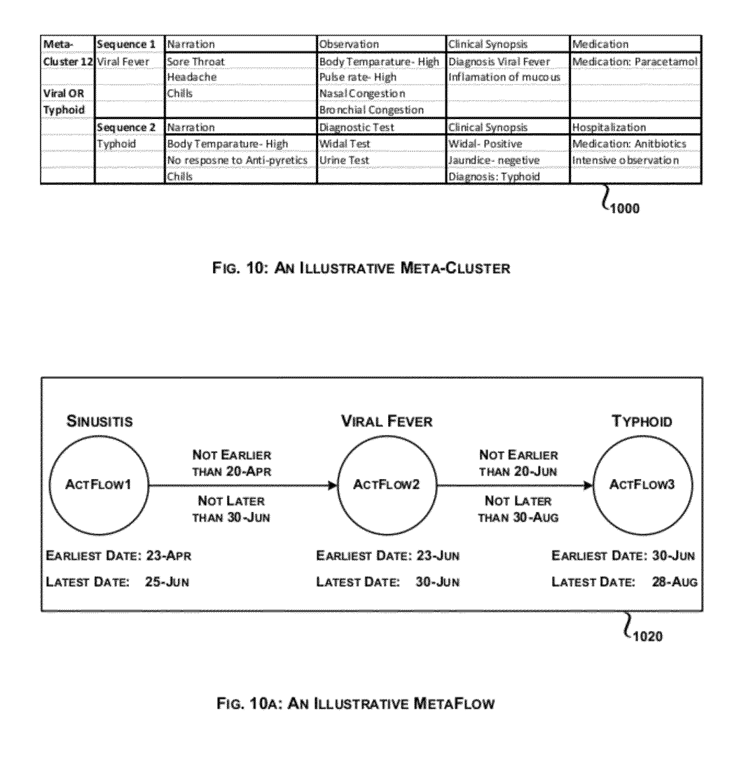

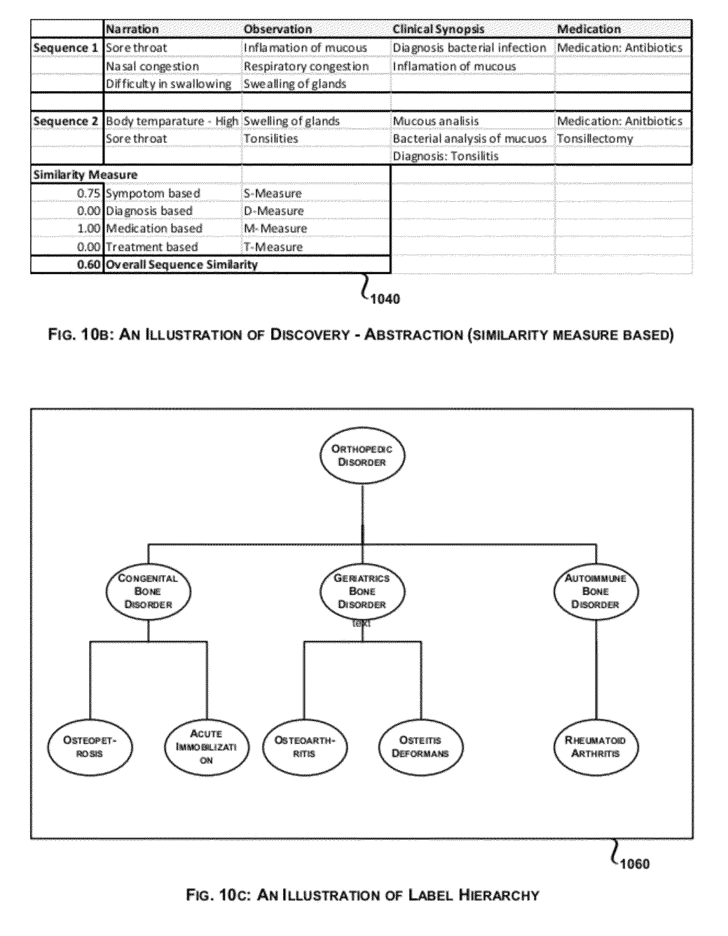

FIG. 10 depicts an illustrative Meta-Cluster. Note that the illustration depicts two sequences—Sequence 1 related to Viral Fever and Sequence 2 related to Typhoid (1000). Based on the set-theoretic union operator, the two sequences are combined to generate a meta-cluster.

FIG. 10A depicts an illustrative MetaFlow. Note that the illustrative metaflow comprises of three meta-nodes (1020): Meta-node 1 is based on actflow1 that is related to Sinusitis; similarly, meta-node 2 is based on the actflow related to Viral Fever while meta-node 3 is based on the actflow related to Typhoid. Typically, such labeled mata-nodes are inter-related temporally, again as depicted.

FIG. 10B provides an illustration of Discovery-Abstraction (similarity measure based). Note that there are two sequences under consideration (1040): both the sequences are described based on their associated pHRs. In the illustration, the similarity measure is defined using four distinct measures: S-measure that is based on similarity with respect to symptoms; D-measure based on diagnosis based similarity; M-measure based on medication similarity; and T-measure based on treatment similarity. And, the overall similarity is obtained by a weighted combination of these individual similarity measures.

FIG. 10C depicts an illustration of Label Hierarchy. Note that this illustrative hierarchy (1060) relates several labels that are used, for example, in labeling the actflows. This kind of hierarchy is used in suitably assigning labels to meta-sequences and meta-clusters.

Thus, a system and method for the analysis and distributable archiving of personal health records is disclosed. Although the present invention has been described particularly with reference to the figures, it will be apparent to one of the ordinary skill in the art that the present invention may appear in any number of systems that perform analysis of person-centric health records. It is further contemplated that many changes and modifications may be made by one of ordinary skill in the art without departing from the spirit and scope of the present invention.

We claim:

1. A system for analysis and distributable archiving of a plurality of personal health records in a personal health database of a person based on a plurality of health related activities, a plurality of health related events, and a plurality of health related actions associated with said person, resulting in a plurality of sequences of said personal health records, a plurality of clusters of said personal health records, a plurality of meta-sequences of said plurality of sequences, and a plurality of meta-clusters of said plurality of clusters and said plurality of sequences, said system comprising:
means for obtaining a plurality of raw data records based on said plurality of health related activities, said plurality of health related events, and said plurality of health related actions, and for making of said plurality raw data records as a part of said personal health database;
means for obtaining of a plurality of dimensions comprising of an accident dimension, a disease dimension, an environment dimension, a narration dimension, an observation dimension, and a lifestyle dimension, and for obtaining of a plurality of sub-dimensions for each of said plurality of dimensions;
means for relating of said plurality of raw data records into a plurality of dimension mapped records, wherein a record dimension of a dimension mapped record of said plurality of dimension mapped records is a dimension of said plurality of dimensions and a sub-dimension of a plurality of sub-dimensions associated with said dimension, and for making of said plurality of dimension mapped records a part of said personal health database;
means for correlating of said plurality of dimension mapped records to generate a plurality of dimension linked records, wherein a dimension linked record of said plurality of dimension linked records is a sequence of said plurality of personal health records of said personal health database, wherein said sequence is a part of said plurality of sequences or a cluster of said plurality of personal health records of said personal health database, wherein said cluster is a part of said plurality of clusters, and for making of said plurality of dimension linked records a part of said personal health database; and
means for discovering a plurality of meta-dimension records based on said plurality of sequences and said plurality of clusters resulting in a plurality of meta-dimension records, wherein a meta-dimension record of said plurality of meta-dimension records is a meta-sequence of said plurality of sequences, wherein said meta-sequence is a part of said plurality meta-sequences or is a meta-cluster of said plurality of clusters, wherein said meta-cluster is a part of said plurality of meta-clusters; and for making of said plurality of meta-dimension records a part of said personal health database.
(BASED ON FIGS. 1, 2, 2A, 3, and 3A)

2. The system of claim 1, wherein said means for obtaining of said plurality raw data records further comprises of:
means for obtaining of a self description record of said plurality raw data records;
means for obtaining of an hospital record of said plurality raw data records;
means for obtaining of a physician description record of said plurality raw data records;
means for obtaining of a nurse description record of said plurality raw data records;
means for obtaining of a diagnostic report record of said plurality raw data records;
means for obtaining of an environmental report record of said plurality raw data records; and
means for obtaining of a lifestyle report record of said plurality raw data records.
(BASED ON FIGS. 4 and 4B)

3. The system of claim 1, wherein said means for relating further comprises of:
means for obtaining of a self description record of said plurality of raw data records;
means for determining a self description ache record based on the textual analysis of said self description record;
means for performing of analysis of said self description ache record based on a medical knowledge source resulting in an analyzed self description ache record;
means for determining of a pain type based on said analyzed self description ache record;
means for determining of a plurality of parameters based on said pain type;
means for instantiating of said plurality of parameters based on said analyzed self description ache record resulting in a plurality of instantiated parameters;
means for determining of a sub-dimension of said narration dimension;
means for creating of a personal health record of said plurality of personal health records based on said narration dimension, said sub-dimension, and said plurality of instantiated parameters;
means for creating of a personal health record of said plurality of personal health records based on said lifestyle dimension if said analyzed self description ache record is associated with an activity of said plurality of activities, wherein said activity is related to lifestyle;
means for creating of a personal health record of said plurality of personal health records based on said environment dimension if said analyzed self description ache record is associated with an activity of said plurality of activities, wherein said activity is related to environment; and
means for creating of a personal health record of said plurality of personal health records based on said accident dimension if said analyzed self description ache record is associated with an event of said plurality of events, wherein said event is related to an accident.
(BASED ON FIG. 5: Step 2)

4. The system of claim 3, wherein said means for relating further comprises of:
means for obtaining of a self description record of said plurality of raw data records;
means for determining a self description sensation record based on the textual analysis of said self description record;
means for performing of analysis of said self description sensation record based on said medical knowledge source resulting in an analyzed self description sensation record;
means for determining of a sensation type based on said analyzed self description sensation record;
means for determining of a plurality of parameters based on said sensation type;
means for instantiating of said plurality of parameters based on said analyzed self description sensation record resulting in a plurality of instantiated parameters;
means for determining of a sub-dimension of said narration dimension;
means for creating of a personal health record of said plurality of personal health records based on said narration dimension, said sub-dimension, and said plurality of instantiated parameters;
means for creating of a personal health record of said plurality of personal health records based on said lifestyle dimension if said analyzed self description sensation record is associated with an activity of said plurality of activities, wherein said activity is related to lifestyle;
means for creating of a personal health record of said plurality of personal health records based on said environment dimension if said analyzed self description sensation record is associated with an activity of said plurality of activities, wherein said activity is related to environment; and
means for creating of a personal health record of said plurality of personal health records based on said accident dimension if said analyzed self description sensation record is associated with an event of said plurality of events, wherein said event is related to an accident.
(BASED ON FIG. 5: Step 3)

5. The system of claim 3, wherein said means for relating further comprises of:
means for obtaining of a self description record of said plurality of raw data records;
means for determining a self description condition record based on the textual analysis of said self description record;
means for performing of analysis of said self description condition record based on said medical knowledge source resulting in an analyzed self description condition record;
means for determining of a condition type based on said analyzed self description condition record;
means for determining of a plurality of parameters based on said condition type;
means for instantiating of said plurality of parameters based on said analyzed self description condition record resulting in a plurality of instantiated parameters;
means for determining of a sub-dimension of said narration dimension;
means for creating of a personal health record of said plurality of personal health records based on said narration dimension, said sub-dimension, and said plurality of instantiated parameters;
means for creating of a personal health record of said plurality of personal health records based on said lifestyle dimension if said analyzed self description condition record is associated with an activity of said plurality of activities, wherein said activity is related to lifestyle;
means for creating of a personal health record of said plurality of personal health records based on said environment dimension if said analyzed self description condition record is associated with an activity of said plurality of activities, wherein said activity is related to environment; and
means for creating of a personal health record of said plurality of personal health records based on said accident dimension if said analyzed self description condition record is associated with an event of said plurality of events, wherein said event is related to an accident.
(BASED ON FIG. 5: Step 4)

6. The system of claim 3, wherein said means for relating further comprises of:
means for obtaining of an hospital record of said plurality of raw data records;
means for performing of analysis of said hospital record based on said medical knowledge source resulting in an analyzed hospital record;
means for determining of an electronic health record based on the textual analysis of said analyzed hospital record;
means for determining of a plurality of parameters based on said electronic health record;
means for instantiating of said plurality of parameters based on said analyzed hospital record resulting in a plurality of instantiated parameters;
means for determining of a dimension of said plurality of dimensions based on said analyzed hospital record;
means for determining of a sub-dimension of said dimension; and
means for creating of a personal health record of said plurality of personal health records based on said dimension, said sub-dimension, and said plurality of instantiated parameters.
(BASED ON FIG. 5: Step 5)

7. The system of claim 3, wherein said means for relating further comprises of:
means for obtaining of a physician description record of said plurality of raw data records;
means for performing of analysis of said physician description record based on said medical knowledge source resulting in an analyzed physician description record;
means for determining an electronic health record based on the textual analysis of said analyzed physician description record;
means for determining of a plurality of parameters based on said electronic health record;
means for instantiating of said plurality of parameters based on said analyzed physician record resulting in a plurality of instantiated parameters;
means for determining of a dimension of said plurality of dimensions based on said analyzed physician description record;
means for determining of a sub-dimension of said dimension; and
means for creating of a personal health record of said plurality of personal health records based on said dimension, said sub-dimension, and said plurality of instantiated parameters.
(BASED ON FIG. 5: Step 6)

8. The system of claim 3, wherein said means for relating further comprises of:
means for obtaining of a physician description record of said plurality of raw data records;
means for performing of textual analysis of said physician description record based on said medical knowledge source resulting in an analyzed physician description record;
means for determining of a plurality of parameters based on said analyzed physician description record;
means for instantiating of said plurality of parameters based on said analyzed physician description record resulting in a plurality of instantiated parameters;
means for determining of a dimension of said plurality of dimension based on analyzed physician description record;
means for determining of a sub-dimension of said narration dimension;
means for creating of a personal health record of said plurality of personal health records based on said narration dimension, said sub-dimension, and said plurality of instantiated parameters; and
means for creating of a personal health record of said plurality of personal health records based on said accident dimension if said analyzed physician description record is associated with an event of said plurality of events, wherein said event is related to an accident.
(BASED ON FIG. 5: Step 6)

9. The system of claim 3, wherein said means for relating further comprises of:
means for obtaining of a nurse description record of said plurality of raw data records;
means for performing of analysis of said nurse description record based on said medical knowledge source resulting in an analyzed nurse description record;
means for determining an electronic health record based on the textual analysis of said analyzed nurse description record;
means for determining of a plurality of parameters based on said electronic health record;
means for instantiating of said plurality of parameters based on said analyzed nurse description record resulting in a plurality of instantiated parameters;
means for determining of a dimension of said plurality of dimensions based on said analyzed nurse description record;
means for determining of a sub-dimension of said dimension; and
means for creating of a personal health record of said plurality of personal health records based on said dimension, said sub-dimension, and said plurality of instantiated parameters.
(BASED ON FIG. 5: Step 7)

10. The system of claim 3, wherein said means for relating further comprises of:
means for obtaining of a nurse description record of said plurality of raw data records;
means for performing of textual analysis of said nurse description record based on said medical knowledge source resulting in an analyzed nurse description record;
means for determining of a plurality of parameters based on said analyzed nurse description record;
means for instantiating of said plurality of parameters based on said analyzed nurse description record resulting in a plurality of instantiated parameters;
means for determining of a dimension of said plurality of dimension based on analyzed nurse description record;
means for determining of a sub-dimension of said narration dimension;
means for creating of a personal health record of said plurality of personal health records based on said narration dimension, said sub-dimension, and said plurality of instantiated parameters; and
means for creating of a personal health record of said plurality of personal health records based on said accident dimension if said analyzed nurse description record is associated with an event of said plurality of events, wherein said event is related to an accident.
(BASED ON FIG. 5: Step 7)

11. The system of claim 3, wherein said means for relating further comprises of:
means for obtaining of a diagnostic record of said plurality of raw data records;
means for performing of analysis of said diagnostic record based on said medical knowledge source resulting in an analyzed diagnostic record;
means for determining an electronic health record based on the textual analysis of said analyzed diagnostic record;
means for determining of a plurality of parameters based on said electronic health record;
means for instantiating of said plurality of parameters based on said analyzed diagnostic record resulting in a plurality of instantiated parameters;
means for determining of a dimension of said plurality of dimensions based on said analyzed diagnostic record;
means for determining of a sub-dimension of said dimension; and
means for creating of a personal health record of said plurality of personal health records based on said dimension, said sub-dimension, and said plurality of instantiated parameters;
(BASED ON FIG. 5: Step 8)

12. The system of claim 3, wherein said means for relating further comprises of:
means for obtaining of an environment report record of said plurality of raw data records;
means for performing of analysis of said environment report record based on said medical knowledge source resulting in an analyzed environment report record;
means for determining an electronic health record based on the textual analysis of said analyzed environment report record;
means for determining of a plurality of parameters based on said electronic health record;
means for instantiating of said plurality of parameters based on said analyzed environment report record resulting in a plurality of instantiated parameters;
means for determining of a sub-dimension of said environment dimension; and
means for creating of a personal health record of said plurality of personal health records based on said environment dimension, said sub-dimension, and said plurality of instantiated parameters.
(BASED ON FIG. 5: Step 9)

13. The system of claim 3, wherein said means for relating further comprises of:
means for obtaining of an environment report record of said plurality of raw data records;
means for performing of textual analysis of said environment report record based on said medical knowledge source resulting in an analyzed physician description record;
means for determining of a plurality of parameters based on said analyzed environment report record;
means for instantiating of said plurality of parameters based on said analyzed environment report record resulting in a plurality of instantiated parameters;
means for determining of a sub-dimension of said narration dimension;
means for creating of a personal health record of said plurality of personal health records based on said narration dimension, said sub-dimension, and said plurality of instantiated parameters; and
means for creating of a personal health record of said plurality of personal health records based on said accident dimension if said analyzed environment report record is associated with an event of said plurality of events, wherein said event is related to an accident.
(BASED ON FIG. 5: Step 9)

14. The system of claim 3, wherein said means for relating further comprises of:
means for obtaining of a lifestyle report record of said plurality of raw data records;
means for performing of analysis of said lifestyle report record based on said medical knowledge source resulting in an analyzed lifestyle report record;
means for determining an electronic health record based on the textual analysis of said analyzed lifestyle report record;
means for determining of a plurality of parameters based on said electronic health record;
means for instantiating of said plurality of parameters based on said analyzed lifestyle report record resulting in a plurality of instantiated parameters;
means for determining of a sub-dimension of said lifestyle dimension; and
means for creating of a personal health record of said plurality of personal health records based on said lifestyle dimension, said sub-dimension, and said plurality of instantiated parameters.
(BASED ON FIG. 5: Step 10)

15. The system of claim 3, wherein said means for relating further comprises of:
means for obtaining of a lifestyle report record of said plurality of raw data records;
means for performing of textual analysis of said environment report record based on said medical knowledge source resulting in an analyzed lifestyle record;
means for determining of a plurality of parameters based on said analyzed lifestyle report record;
means for instantiating of said plurality of parameters based on said analyzed lifestyle report record resulting in a plurality of instantiated parameters;
means for determining of a sub-dimension of said narration dimension;
means for creating of a personal health record of said plurality of personal health records based on said narration dimension, said sub-dimension, and said plurality of instantiated parameters; and
means for creating of a personal health record of said plurality of personal health records based on said accident dimension if said analyzed lifestyle record is associated with an event of said plurality of events, wherein said event is related to an accident.
(BASED ON FIG. 5: Step 10)

16. The system of claim 1, wherein said means for correlating further comprises of:
means for obtaining an actflow of a plurality of actflows;
means for determining of a plurality of nodes of said actflow, wherein a node of said plurality of nodes denotes an activity by said person or a related person such as a physician, a nurse, or a lab technician, and comprises of both temporal and spatial information;
means for obtaining of a plurality of parameters associated with a node of said plurality of nodes, wherein a parameter of said plurality of parameters is an activity specific parameter, actflow specific parameter, or specific to a plurality of actflows, and said parameter is a mandatory parameter or an optional parameter;
means for obtaining of an edge associated with said actflow, wherein said edge connects a node 1 of said plurality of nodes and a node 2 of said plurality of nodes; and
means for obtaining of a function associated with said edge, wherein said function is based on a plurality of parameters associated with said node 1 and a plurality of parameters associated with said node 2.
(BASED ON FIGS. 7 and 7A)

17. The system of claim 16, wherein said means further comprises of:
means for obtaining of a node 1 of said plurality of nodes of said actflow;
means for obtaining of a node 2 of said plurality of nodes of said actflow, wherein said node 2 is connected to said node 1 through an edge;
means for determining of a plurality of node 1 personal health records based on a plurality of parameters associated with said node 1 and a plurality of field values associated with each of said plurality of personal health records;
means for associating of an extent of match score with each of said plurality of node 1 personal health records;
means for determining of a plurality of node 2 personal health records based on a plurality of parameters associated with said node 2 and a plurality of field values associated with each of said plurality of personal health records
means for associating of an extent of match score with each of said plurality of node 2 personal health records;
means for obtaining of a function associated with said edge;
means for computing of a plurality of node 2 updated personal health records based on said plurality of node 1 personal health records, said plurality of node 2 personal health records, and said function; and
means for assigning of said plurality of node 2 updated personal health records as said plurality of node 2 personal health records.
(BASED ON FIG. 7B: Steps 1-4A)

18. The system of claim 16, wherein said means further comprises of:
means for obtaining of an actflow of said plurality of actflows;
means for determining of a path of said actflow;
means for determining of a plurality of sequenced nodes associated with said path;
means for determining of a plurality of functions associated with said path; and
means for determining of a plurality of updated personal health records associated with each sequence node of said plurality of sequenced nodes based on said plurality of functions.
(BASED ON FIG. 7B: Steps 5-8)

19. The system of claim 18, wherein said means further comprises of:
means for forming of a cluster of said plurality of clusters based on said plurality of updated personal health records associated with each sequence node of said plurality of sequenced nodes; and
means for labeling of said cluster based on a label associated with said actflow and said path.
(BASED ON FIG. 7B: Step 11)

20. The system claim 18, wherein said means further comprises of:
means for obtaining of a first sequence node of said plurality of sequenced nodes;
means for determining a plurality of first sequence node personal health records based on said first sequence node;
means for forming of a root node of a tree based on a first sequence node personal health record of said plurality of first sequence node personal health records;
means for obtaining of a second sequence node of said plurality of sequenced nodes;
means for determining of a plurality of second sequence node personal health records based on said second sequence node;
means for forming of a plurality of child nodes of said root node of said tree based on said first sequence node personal health record, said plurality of second sequence node personal health records, and said plurality of functions;
means for forming of a sequence of said plurality of sequences based on a path through said tree; and
means for labeling of said sequence based on a label of said actflow and said path.
(BASED ON FIG. 7B: Steps 12-15a)

21. The system of claim 16, wherein said means further comprises of:
means for obtaining of a plurality of link dimension, wherein said plurality of link dimensions consists of: a symptom dimension, a medication dimension, a treatment dimension, a physician dimension, a temporal dimension, and a spatial dimension;
means for obtaining of a link dimension of said plurality of link dimensions;
means for obtaining of a plurality of link characteristics based on said link dimension;
means for identifying of a personal health record of said plurality of personal health records based on said plurality of link characteristics;
means for updating of a link cluster based on said personal health record;
means for obtaining of a plurality of link neighborhood rules based on said link dimension; and
means for updating of said link cluster based on said link cluster, said plurality of personal health records, and said plurality of link neighborhood rules.
(BASED ON FIGS. 7C and 7D)

22. The system of claim 1, wherein said means for discovering further comprises of:
means for obtaining of a plurality of labeled sequences based on said plurality of sequence;
means for obtaining of a plurality of sequence labels associated with said plurality of labeled sequences;
means for obtaining of a plurality of labeled clusters based on said plurality of clusters;
means for obtaining of a plurality of cluster labels based on said plurality of labeled clusters;
means for combining of said plurality of labeled sequences and said plurality of labeled clusters resulting a plurality of combined personal health records;
means for combining of said plurality of sequence labels and said plurality of cluster labels resulting in a plurality of combined labels;
means for determining of a plurality of minimum number of labels of said plurality of combined labels, wherein each of said plurality of combined labels is within a pre-defined threshold from a label of said plurality of minimum number of labels; and
means for making of said plurality of combined personal health records along with said plurality of minimum number of labels a part of said plurality of meta-clusters.
(BASED ON FIG. 9: Steps 1-6)

23. The system of claim 22, wherein said means further comprises of:
means for determining of a plurality of subset of labels based on said plurality of combined labels, wherein a label of said plurality of subset of labels is within a pre-defined threshold from a label 1 of said plurality of subset of labels;
means for computing of a plurality of intersection personal health records based on a plurality of personal health records associated with each of said plurality of subset of labels; and
means for making of said plurality of intersection personal health records along with said plurality of subset of labels a part of said plurality of meta-clusters.
(BASED ON FIG. 9: Steps 7-13)

24. The system of claim 22, wherein said means further comprises of:
means for obtaining of a metaflow of a plurality of metaflows;
means for determining of a plurality of metaflow nodes associated with said metaflow;
means for determining of a plurality of labels associated with a metaflow node of said plurality of metaflow nodes;
means for determining an edge, wherein said edge interconnects a metaflow node 1 of said plurality of metaflow nodes and a metaflow node 2 of said plurality of metaflow nodes; and
means for associating a temporal characteristic with said edge, wherein said temporal characteristic relates a plurality of labels associated with said metaflow node 1 and a plurality of lables associated with said metalfow node 2.
(BASED ON FIGS. 9A and 9B)

25. The system of claim 24, wherein said means further comprises of:
means for obtaining of a path of said metaflow;
means for determining of a plurality of path metaflow nodes based on said path;
means for determining of a plurality of labels associated with a node of said plurality of path metaflow nodes;
means for determining of a plurality of metaflow node personal health records based on said plurality of labels;
means for updating of a plurality of metaset personal health records based on said plurality of metaflow node personal health records;
means for obtaining of a metarule set associated with said metaflow;
means for applying of said metarule set on said plurality of metaset personal health records resulting a meta-cluster of said plurality of meta-clusters;
means for making of a meta-sequence of said plurality of meta-sequences based on said meta-cluster and said metalfow;
means for associating of a label of said metalfow with said meta-cluster; and
means for associating of a label of said metalfow with said meta-sequence.
(BASED ON FIG. 9B: Steps 14-22)

26. The system of claim 22, wherein said means further comprises of:
means for obtaining a seed, wherein said seed is a sequence of said plurality of sequences or a cluster of said plurality of sequences;
means for determining a seed label associated with said seed;
means for determining a plurality of seed similar sequences based on said seed, said seed label, said plurality of sequences, a similarity measure, a medical knowledge source, and a pre-defined threshold;
means for determining a plurality of seed similar clusters based on said seed, said plurality of clusters, a similarity measure, a medical knowledge source, and a pre-defined threshold;
means for combining said plurality of seed similar sequences and said plurality of seed similar clusters resulting in a meta-cluster of said plurality of meta-clusters;
means for determining a plurality of combined labels based on a plurality of labels associated with said plurality of seed similar sequences and a plurality of labels associated with said plurality of seed similar clusters;
means for determining a meta-cluster label based on said plurality of combined labels; and
means for associating said meta-cluster label with said meta-cluster.
(BASED ON FIG. 9B: Steps 23-27)
